(19) United States
(12) Patent Application Publication
(10) Pub. No.: US 2022/0058583 A1
(43) Pub. Date: Feb. 24, 2022

(54) PROJECT MANAGEMENT SYSTEMS AND METHODS

(71) Applicant: ProjectX Platform, LLC, Lakeland, FL (US)

(72) Inventors: Matthew Brian Thompson, Lakeland, FL (US); David Richard Lapham, Lakeland, FL (US); James E. Carey, III, Lakeland, FL (US)

(73) Assignee: ProjectX Platform, LLC, Lakeland, FL (US)

(21) Appl. No.: 17/000,038

(22) Filed: Aug. 21, 2020

(51) Int. Cl. G06Q 10/10; G06Q 30/02

(52) U.S. Cl. CPC G06Q 10/103; G06Q 10/1095; G06Q 30/0214

(57) ABSTRACT

Computer-implemented project management platform methods, systems, and computer-readable media are described.

### FIELD

Some implementations are generally related to computer-based project management systems and methods, and in particular, to systems and methods for an end-to-end project management platform for projects including multiple phases such as marketing, sales, production, onboarding, and/or payment processing, and multiple participants at each phase.

### BACKGROUND

Some existing project management tools may focus only on one or a limited number of aspects of a project such as schedule or cost. However, some projects may entail multiple phases that each may involve multiple participants. Such projects may also have a life cycle, for example, from marketing to production to payout of payments to participants. Existing project management tools may not offer an integrated solution for managing such projects. Accordingly, a need may exist for an integrated project management platform that provides project management capabilities spanning all phases of a project and that provides communication and payment tools to connect the various participants through the project management platform.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method to operate a project management platform. The method can include automatically generating, at one or more processors, a telephone number, and associating, at the one or more processors, the telephone number with a referral source in a database of the project management platform. The method can also include receiving, at the one or more processors, an inbound telephone call and dialed number identification information that identifies a dialed number of the inbound telephone call as the telephone number, and routing, using the one or more processors, the inbound telephone call to a telephone associated with the project management platform.

The method can further include receiving, at the one or more processors, scheduling information for a new appointment for a customer associated with the inbound telephone call, adding, using the one or more processors, the new appointment to an electronic calendar, and adding, using the one or more processors, tentative referral payout information to the database, where the tentative referral payout information is directed to the referral source associated with the telephone number.

In some implementations, the scheduling information for the new appointment includes a new appointment location, and the method further includes displaying a color-coded calendar showing existing appointments color coded by a geographic location zone. In some implementations, the method further includes generating and displaying a warning if an attempt is made to schedule the new appointment at a time slot adjacent to an existing appointment having a location in a zone different from a zone associated with the new appointment location.

In some implementations, the method further includes automatically suggesting a proposed time slot for the new appointment, wherein the proposed time slot is adjacent to an existing appointment in a same zone as the new appointment location. In some implementations, automatically suggesting the proposed time slot includes determining the proposed time slot based on a location of one or more adjacent existing appointments to the proposed time slot and providing sufficient time between the proposed time slot and the one or more adjacent existing appointments for travel between appointment locations.

In some implementations, the telephone number is automatically generated as part of a referral source onboarding process. The method can also include associating the referral source with a referral payment card account. In some implementations, the referral payment card account is a tenant account of a master account associated with an operator of the project management platform. In some implementations, the referral payment card account is associated with a branded payment card having a brand of the operator of the project management platform applied to the branded payment card.

Some implementations can include a project management platform system comprising one or more processors coupled to a computer-readable medium having stored thereon software instructions that, when executed by the one or more processors, cause the one or more processors to perform operations. The operations can include automatically generating, at the one or more processors, a telephone number, and associating, at the one or more processors, the telephone number with a referral source in a database of the project management platform. The operations can also include receiving, at the one or more processors, an inbound telephone call and dialed number identification information that identifies a dialed number of the inbound telephone call as the telephone number, and routing, using the one or more processors, the inbound telephone call to a telephone associated with the project management platform.

The operations can further include receiving, at the one or more processors, scheduling information for a new appointment for a customer associated with the inbound telephone call, and adding, using the one or more processors, tentative referral payout information to the database, where the tentative referral payout information is directed to the referral source associated with the telephone number.

In some implementations, the scheduling information for the new appointment includes a new appointment location, and the operations further include displaying a color-coded calendar showing existing appointments color coded by a geographic location zone. In some implementations, the operations further include generating and displaying a warning if an attempt is made to schedule the new appointment at a time slot adjacent to an existing appointment having a location in a zone different from a zone associated with the new appointment location.

In some implementations, the operations further include automatically suggesting a proposed time slot for the new appointment, wherein the proposed time slot is adjacent to an existing appointment in a same zone as the new appointment location. In some implementations, automatically suggesting the proposed time slot includes determining the proposed time slot based on a location of one or more adjacent existing appointments to the proposed time slot and providing sufficient time between the proposed time slot and the one or more adjacent existing appointments for travel between appointment locations.

In some implementations, the telephone number is automatically generated as part of a referral source onboarding process. The operations can further include associating the referral source with a referral payment card account. In some implementations, the referral payment card account is a tenant account of a master account associated with an operator of the project management platform. In some implementations, the referral payment card account is associated with a branded payment card having a brand of the operator of the project management platform applied to the branded payment card.

Some implementations can include a computer-readable medium having stored thereon software instructions that, when executed by one or more processors, cause the one or more processors to perform operations. The operations can include automatically generating, at the one or more processors, a telephone number, and associating, at the one or more processors, the telephone number with a referral source in a database of the project management platform. The operations can also include receiving, at the one or more processors, an inbound telephone call and dialed number identification information that identifies a dialed number of the inbound telephone call as the telephone number, and routing, using the one or more processors, the inbound telephone call to a telephone associated with the project management platform.

The operations can further include receiving, at the one or more processors, scheduling information for a new appointment for a customer associated with the inbound telephone call, and adding, using the one or more processors, tentative referral payout information to the database, where the tentative referral payout information is directed to the referral source associated with the telephone number.

In some implementations, the scheduling information for the new appointment includes a new appointment location, and the operations further include displaying a color-coded calendar showing existing appointments color coded by a geographic location zone. In some implementations, the operations further include generating and displaying a warning if an attempt is made to schedule the new appointment at a time slot adjacent to an existing appointment having a location in a zone different from a zone associated with the new appointment location.

In some implementations, the operations further include automatically suggesting a proposed time slot for the new appointment, wherein the proposed time slot is adjacent to an existing appointment in a same zone as the new appointment location. In some implementations, automatically suggesting the proposed time slot includes determining the proposed time slot based on a location of one or more adjacent existing appointments to the proposed time slot and providing sufficient time between the proposed time slot and the one or more adjacent existing appointments for travel between appointment locations.

In some implementations, the telephone number is automatically generated as part of a referral source onboarding process. The operations can further include associating the referral source with a referral payment card account. In some implementations, the referral payment card account is a tenant account of a master account associated with an operator of the project management platform. In some implementations, the referral payment card account is associated with a branded payment card having a brand of the operator of the project management platform applied to the branded payment card.

### BRIEF DESCRIPTION OF THE DRAWINGS

FIG. 1A is a block diagram of example systems and a network environment which may be used for one or more implementations described herein;

FIG. 1B is a block diagram of example systems and a network environment which may be used for one or more implementations described herein;

FIG. 2 is a diagram illustrating an example marketing subsystem, according to some implementations;

FIG. 3 is a flow diagram illustrating an example sales process project management method, according to some implementations;

FIG. 4A is a flow diagram illustrating an example production process project management method, according to some implementations;

FIG. 4B is a flow diagram illustrating an example task approval process project management method, according to some implementations;

FIG. 5 is a flow diagram illustrating an example payout process project management method, according to some implementations;

FIG. 6 is a flow diagram illustrating an example onboarding process project management method, according to some implementations;

FIG. 7 is an example graphical user interface showing a pre-measurement checklist for a project, according to some implementations;

FIG. 8 is an example graphical user interface showing a project sections interface, according to some implementations;

FIG. 9 is an example graphical user interface showing a project sections summary, according to some implementations;

FIG. 10 is an example graphical user interface showing project section builder detail to input details of a section of a project, according to some implementations;

FIG. 11 is an example graphical user interface showing a pricing table for a project, according to some implementations;

FIGS. 12 and 13 show an example graphical user interface for a project estimate, according to some implementations;

FIGS. 14 and 15 show an example graphical user interface for a project invoice, according to some implementations;

FIG. 16 is an example graphical user interface showing a dashboard displaying sales appointments, subcontractor tasks, and open deals, according to some implementations;

FIGS. 17 and 18 show an example graphical user interface of a project management production chart, according to some implementations;

FIG. 19 is an example graphical user interface showing a subcontractor (or referral agent) onboarding screen, according to some implementations;

FIG. 20 is a diagram of an example geographic area divided into three zones in accordance with some implementations;

FIG. 21 is a flow diagram illustrating an example scheduling process utilizing the zones of FIG. 20, according to some implementations;

FIG. 22 is a flow diagram illustrating an example scheduling process utilizing the zones of FIG. 20, according to some implementations;

FIG. 23 is a block diagram of an example computing device which may be used for one or more implementations described herein.

FIG. 24 is a block diagram of an example referral and referral gamification system in accordance with some implementations.

FIG. 25 is a flowchart of an example method for referral and referral gamification in accordance with some implementations.

FIG. 26 is a diagram of an example referral and referral gamification mobile application graphical user interface in accordance with some implementations.

### DETAILED DESCRIPTION

Some implementations include project management platform methods and systems.

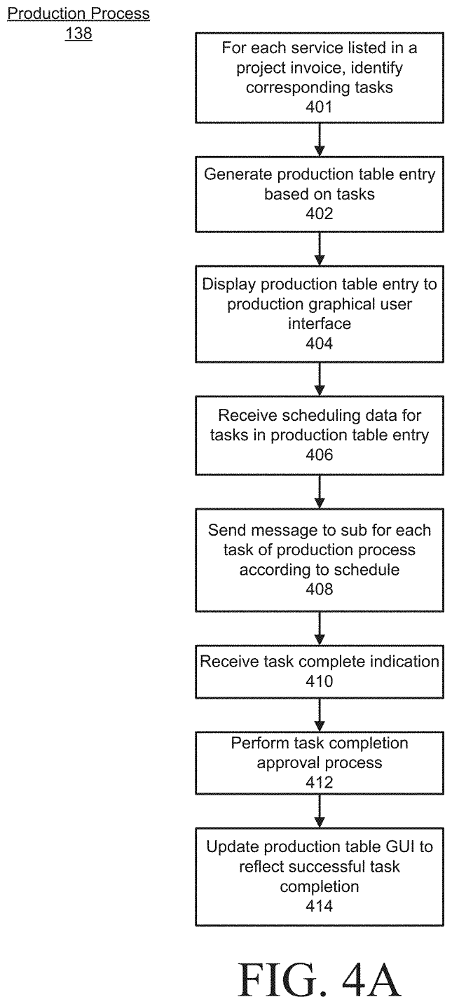

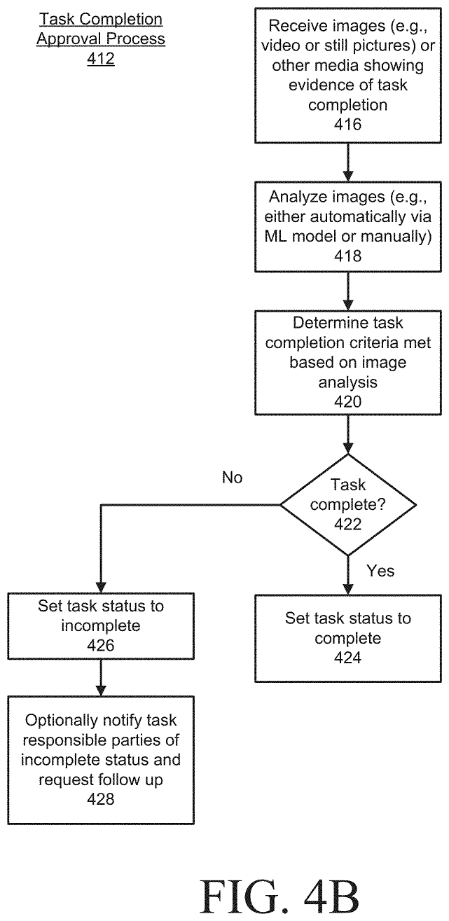

When performing project management functions, it may be helpful for a project management system to suggest one or more tasks for a given project and/or to make predictions about whether a task in a given project is complete. To make project management predictions or suggestions, a probabilistic model (or other model as described below in conjunction with FIG. 4) can be used to make an inference (or prediction) about aspects of project management such as whether a task is complete or suggestions for one or more tasks. Accordingly, it may be helpful to make an inference regarding a probability that a task may be needed for a given project or that a task is complete for a given project. Other project management aspects can be predicted or suggested as described below.

The inference based on the probabilistic model can include predicting whether a task is needed for a project, the scope of a task or project, and/or whether a task or project is complete in accordance with image (or other data) analysis and confidence score as inferred from the probabilistic model. The probabilistic model can be trained with data including previous project data. Some implementations can include generating a project management suggestion for a project-based on images or data associated with project.

The systems and methods provided herein may overcome one or more deficiencies of some conventional project management systems and methods. For example, project management includes enabling users to plan and track projects. With the easy availability of digital image capture devices, such as digital cameras, phones with built-in cameras, wearable devices with cameras, head-mounted devices, tablets, personal computers, etc., users may capture a large number of images or other data about a project. Conventional project management systems may enable users to manually manage tasks or projects. Conventional project management systems may permit users to manually indicate tasks or projects completed and may require manual entry of project tasks. Conventional project management systems may not provide automatic subcontractor payout on completion of project tasks, may not provide an automatic project task completion determination, automatic project or task scope determination, etc., which may be useful to a user.

The example systems and methods described herein may overcome one or more of the deficiencies of conventional project management systems to provide users with automated project management, referral tracking, subcontractor payout and end-to-end management of projects. A technical problem of some conventional project management systems may be that such systems do not suggest project scope and/or task or predict when a task is completed based on project images and corresponding confidence scores. In conventional project management systems, views of projects may not include a visual indication of zones about where projects are located. In these systems, projects in different geographic zones may be displayed alongside each other. Display of projects in such views may provide an undesirable user experience. For example, a view that displays projects may include projects that are adjacent on a display but are located in different geographic zones. Also, some conventional project management systems may not show a visual indication of project timeliness.

Particular implementations may realize one or more of the following advantages. An advantage of project management based on methods and system described herein is that the suggestions are based on project data (e.g., images) and confidence. Yet another advantage is that the methods and systems described herein can dynamically learn new thresholds (e.g., for confidence scores, etc.) and provide suggestions for project management that match the new thresholds. The systems and methods presented herein automatically provide project management suggestions that are more likely to be accepted by users and that likely are more accurate.

An image may be a static image (e.g., a single frame with no motion), an animated image, a video (e.g., with a plurality of frames), etc. For example, a static image may depict one or more objects, while an animated image may depict one or more objects that change within the image (e.g., a live photo that captures a face with eyes transitioning between closed and open, face with the mouth moving from a non-smiling to a smiling position, etc.). In some implementations, an animated image may include both verbal and visual instructions that can be used to provide information about the project in a more detailed way. A video may include a plurality of frames that depict one or more persons. Functional image archiving suggestions may be provided for any type of image and may include a group of images of same and/or different types.

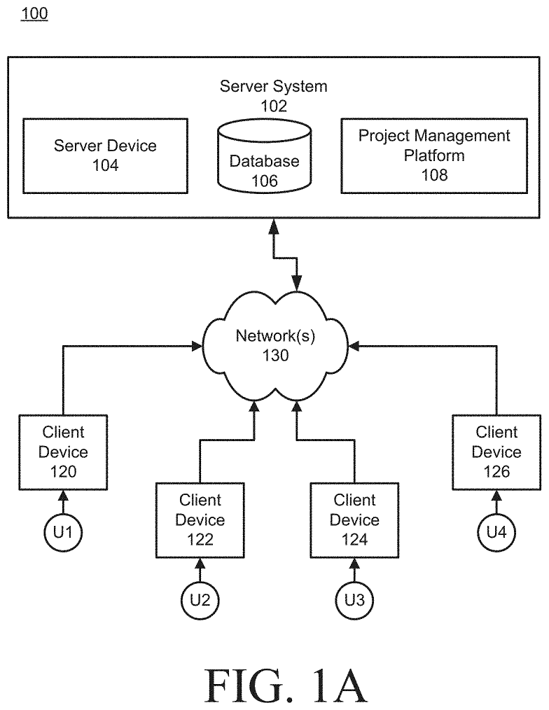

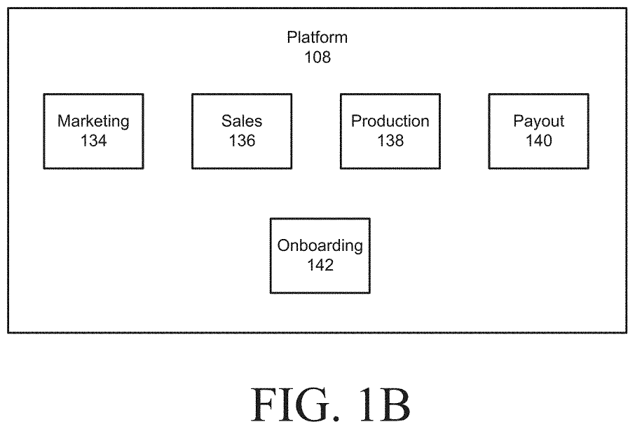

FIG. 1A illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104 and a database 106 or other data store or data storage device. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, mobile networks (including 4G LTE, 5G networks, and future protocols), switch or hub connections, etc. In some implementations, network 130 can include peer-to-peer communication 132 between devices, e.g., using peer-to-peer wireless protocols.

For ease of illustration, FIG. 1A shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide a functional image archiving program. The functional image archiving program may allow a system (e.g., client device or server device) to provide suggestions for archiving images that are likely to be functional images, some examples of which are described herein. The functional image archiving program can provide associated user interface(s) that are displayed on a display device associated with the server system or client device. The user interface may provide various options to a user to select archive images, etc. Other applications can also be used with one or more features described herein, such as image management applications, browsers, email applications, communication applications, etc.

Various implementations of features described herein can use any type of system and/or service. Any type of electronic device can make use of features described herein. Some implementations can provide one or more features described herein on client or server devices disconnected from or intermittently connected to computer networks.

FIG. 1B is a diagram of the project management platform 108 showing functional modules (or functionality sections) within the platform including a marketing module 134, a sales module 136, a production module 138, a payout module 140, and an on boarding module 142. The modules shown in FIG. 1B can be separate, standalone code modules or can be logical functional units comprising one or more code modules within the same or different computer software code. Details of each functional module are discussed below.

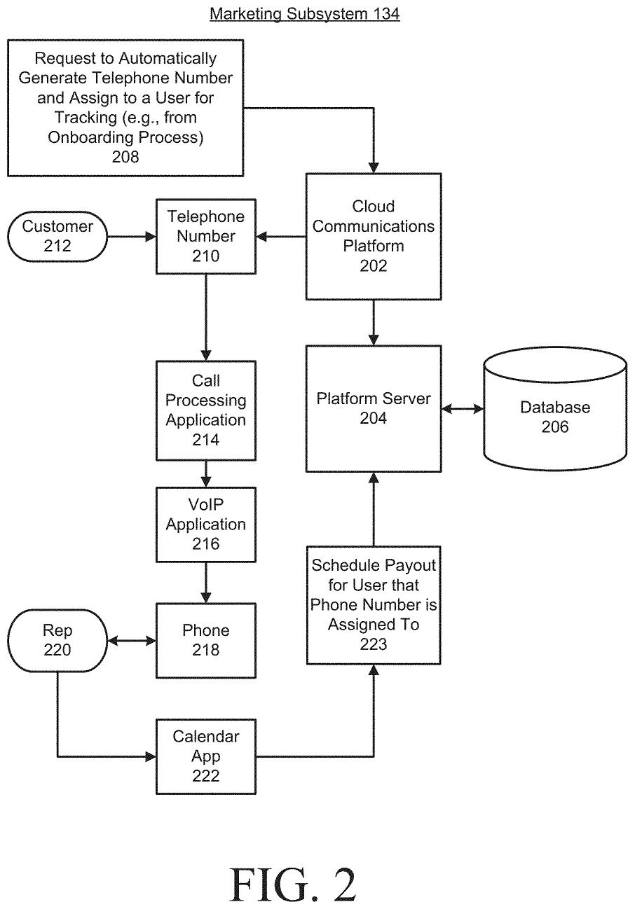

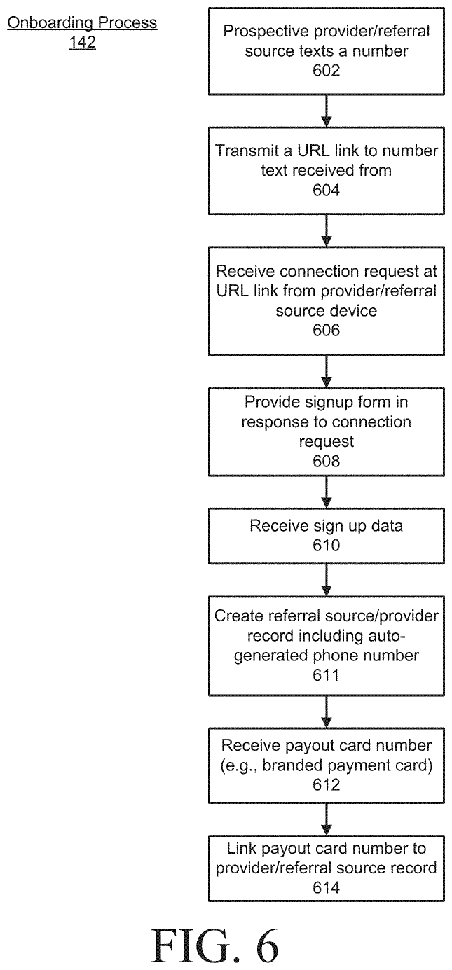

FIG. 2 is a diagram illustrating functions and components of an example marketing subsystem 134. A request 208 is received to automatically generate a telephone number and assign the telephone number to a user (e.g., a referral agent or source) for tracking. The request 208 can be generated as part of a referral agent onboarding process (e.g., as described below in connection with FIG. 6). The request 208 is received at a cloud communications platform 202 (e.g., a platform including or connected to a cloud communications service provider) that automatically generates a telephone number 210 and assigns (or associates) the telephone number 210 with a user such as a referral agent, referral source, influencer, etc. For example, a referral source for a sod business can include a plant nursery, a law spray service provider, a lawn maintenance company, a plant or garden social media influencer, etc. The telephone number 210 can be associated with a referrer and/or with a specific sign or signs (e.g., placed at a plant nursery or garden center), a specific marketing campaign (to measure the campaign performance or results), etc. By associating a telephone number with a referrer, sign, campaign or the like, the project management platform can track the performance such as referrals and sales based on calls to the telephone number 210. The telephone number 210 and/or the association with a referral source can be sent to the platform server 204 and stored in a database 206. In some implementations, the platform can generate a referral link unique to each referral agent, which link, if used by a client to book an appointment, is tracked the same as a telephone number. The referral link can be generated in addition to a telephone number or as an alternative to the telephone number.

When a customer (or prospective customer) 212 calls the telephone number 210 the call is received by the cloud communications platform 202 and routed to the platform server 204, which creates a record of the call and re-routes the call to a call processing application 214 that identifies the dialed number (e.g., the telephone number 210) called by the customer 212. The call is passed from the call processing application 214 to a voice over IP (VoIP) application 216 to a phone (e.g., an Internet based VoIP phone set) 218. A representative 220 can answer the call on the phone 218 and schedule an appointment with the customer 212. The telephone number the customer dialed and the customer's telephone number may be displayed for the representative 220. The representative 220 can use a calendar application 222 to add the appointment for the customer to the calendar. The appointment can include the customers number and can be used to match the appointment to the customer in the platform server 204. For example, for a sod company, the incoming call from a prospective customer could be handled by setting an appointment for a representative of the sod company to visit the customer's house or business to provide an estimate for sod services. Telephone calls are used here for example purposes, but other contact types can be used such as accessing URLs, texting or dialing wireless phone short codes, text messaging, etc.

In addition to setting the appointment for the customer or prospective customer, the process can include adding a deal record to the database and an associated tentative referral fee payout 223 that is associated with the referral source that the phone number 210 is associated with or assigned to in the project management system. In some implementations, the deal record can include a deal ID and all other information about the project can be associated with the deal ID in the database. The appointment data and/or the scheduled tentative referral fee payout data can be stored in the database 206 connected to the platform server 204. In some implementations, the appointment data can be stored in a cloud calendar or scheduling system and/or in an internal database (e.g., 206).

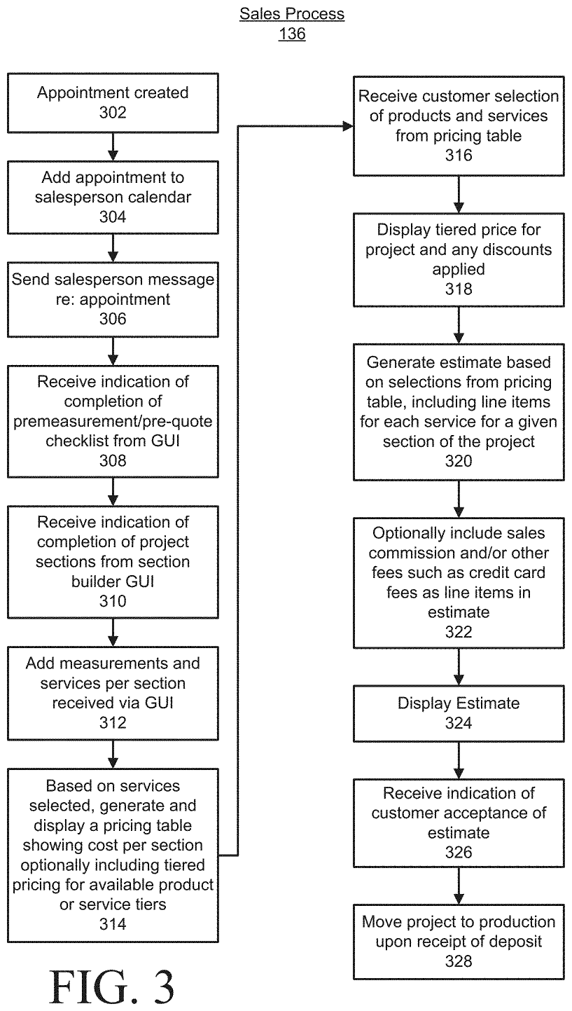

FIG. 3 is a flow diagram illustrating an example method 136 to manage a sales process via the project management platform, according to some implementations.

In some implementations, method 136 can be implemented, for example, on a server system 102 as shown in FIG. 1A. In other implementations, some or all of the method 136 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 136.

Some implementations can initiate method 136 based on user input. A user may, for example, have selected the initiation of the method 136 from a displayed user interface. In some implementations, method 136 or portions thereof can be performed with guidance by the user via user input.

In some implementations, the method 136, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 136, and/or one or more other events or conditions occurring which can be specified in settings of a device implementing method 136. In some implementations, such conditions can be previously specified by a user in stored custom preferences of the user (accessible by a device or method with user consent).

The method begins at block 302, where an appointment is created from data input to the project management platform (e.g., an appointment from the marketing process described in connection with FIG. 2). The process continues to 304.

At 304, the appointment data is added to an electronic calendar of a salesperson associated with the project management platform. The electronic salesperson calendar could include a calendar that is internal to the project management platform or could include an external calendar or appointment scheduling service that is provided by an external calendar or appointment service. Processing continues to 306.

At 306, an electronic message is sent to the salesperson to notify the salesperson of the appointment. The electronic message can include a text message, an email, or other electronic message. Processing continues to 308.

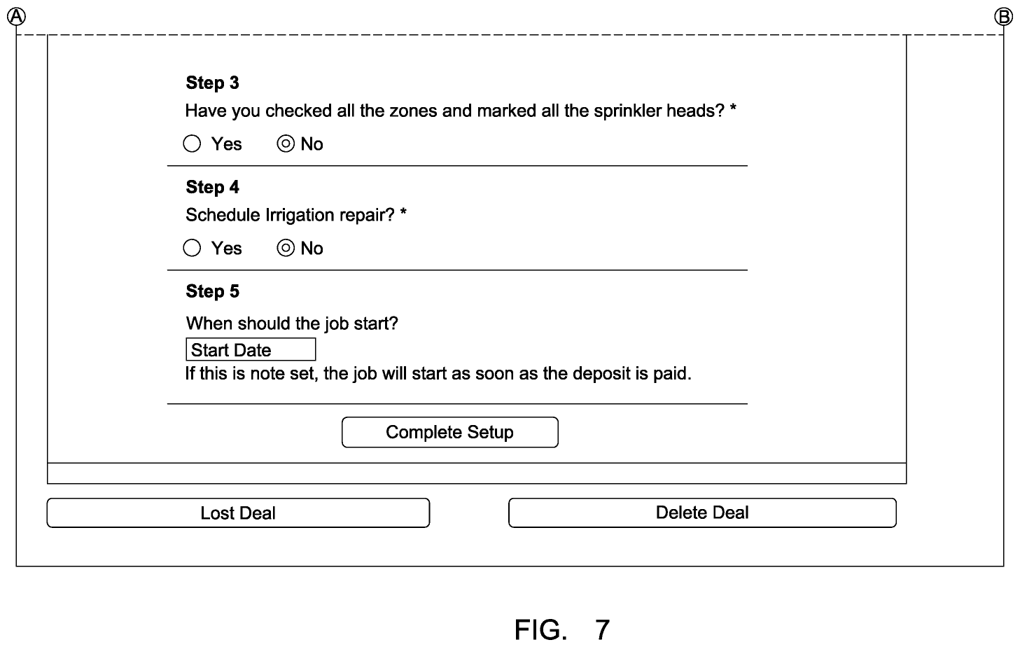

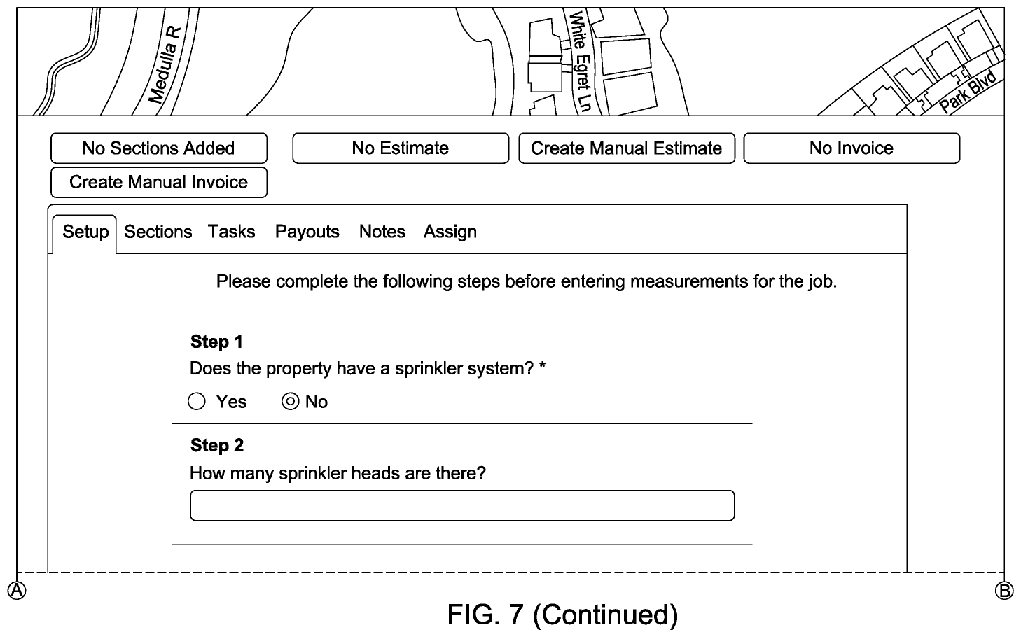

At 308, an indication of completion of a premeasurement or pre-quote checklist is received at the project management platform from a system or device used by the salesperson (or other personnel) during or at the conclusion of the appointment with the customer or prospective customer. The indication can be in the form of an entry to a graphical user interface of a mobile app connected to the project management platform or via another interface such as a browser interface to the project management platform. The indication of completion can include data associated with the premeasurement or pre-quote checklist (see, e.g., FIG. 7 and corresponding description below). The premeasurement checklist can include a project start date. Processing continues to 310.

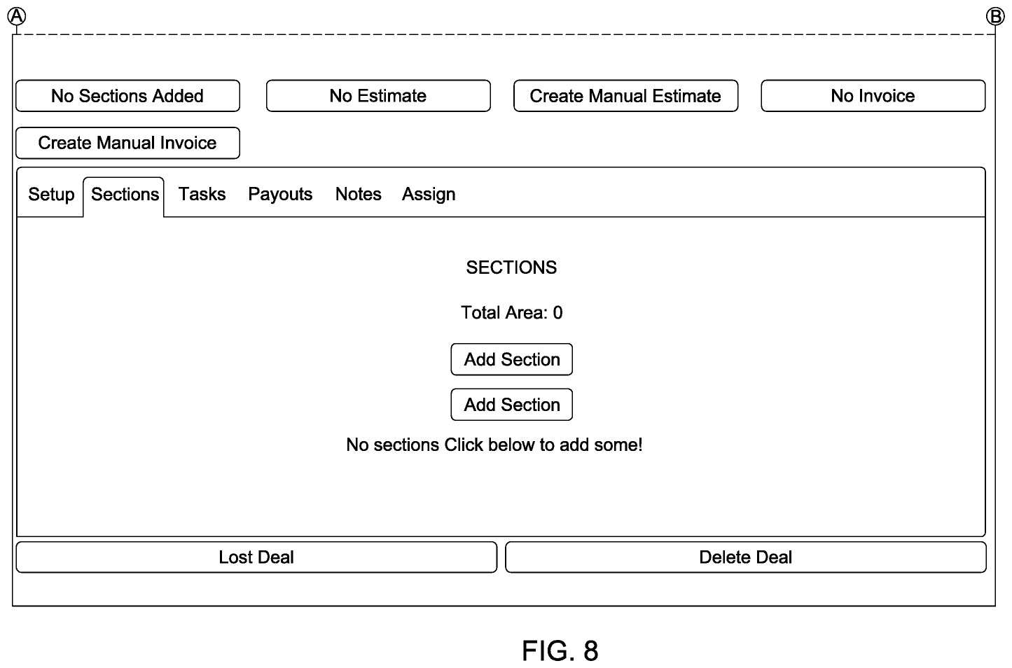

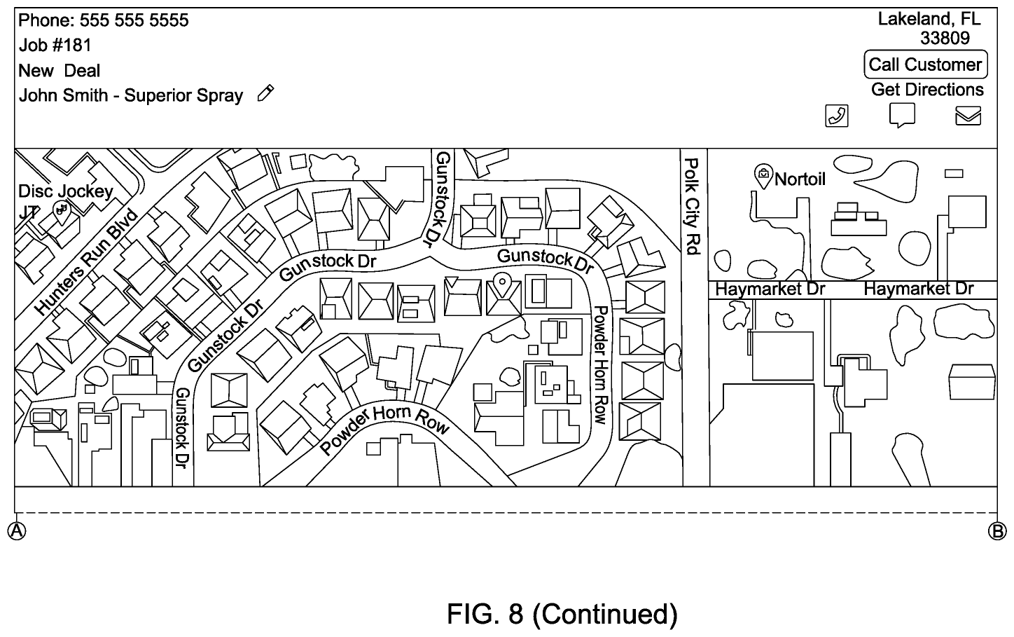

At 310, an indication of project sections is received at the project management platform. The indication can be received from a section builder GUI (e.g., FIGS. 8-10 and corresponding description below. The section builder GUI of a mobile application connected to the project management platform or part of a browser interface to the project management platform. The indication of project sections can include data shown in the example project builder GUIs of FIGS. 8-10 or other suitable data for specifying a project section. Processing continues to 312.

At 312, measurements and/or services are added to the sections specified in block 310. For example, the measurement can be entered manually into a GUI based on measurements taken of the project sections. In some implementations, measurements can be automatically acquired for each section using electronic measurement devices, map data or device location systems. Some implementations can include a motion-based measurement system to acquire measurements for sections (e.g., sections of a yard for a sod project, etc.). Some implementations can include a GPS measurement system or other electronic location measurement system to acquire measurements for sections (e.g., sections of a yard for a sod project, etc.). The measurements for each section are acquired, associated with the corresponding section and stored in a data store. In addition to measurements, the project management platform can receive images or videos of the sections in order to automatically make recommendations on products or services for each section. For example, in a sod business, the images or videos of sections of yard can be automatically analyzed by the project management platform (e.g., using a machine learning model and/or other input such as a subject matter expert) to generate a recommendation for each section. For example, if a given section is shaded and another is in full sun, the project management platform may generate a recommendation of a first sod type for the shaded section and a different sod type for the full sun section. Also, by automatically analyzing the images or video, the project management platform can provide automatic recommendations of other services or products needed in connection with a job such as ground leveling, pest treatment, irrigation servicing, etc. The automated measuring and product/service suggestion can be applied to a variety of industries where measurements (i.e., the size of sections of project) and a visual inspection of the project sections (i.e., indicating a need for one or more services or products) can be used as a basis for product/service recommendations.

In addition to the measurements and images/videos of each section, one or more selected services and/or one or more conditions can be received for each section. For example, a front yard section may include measurements, images, an indication of shady conditions, and a selected type of service such as a sod variety to be installed. In some implementations, the project management system can generate and display a warning when a selected service (e.g., a type of sod) is not compatible with a condition (e.g., shade). Processing continues to 314.

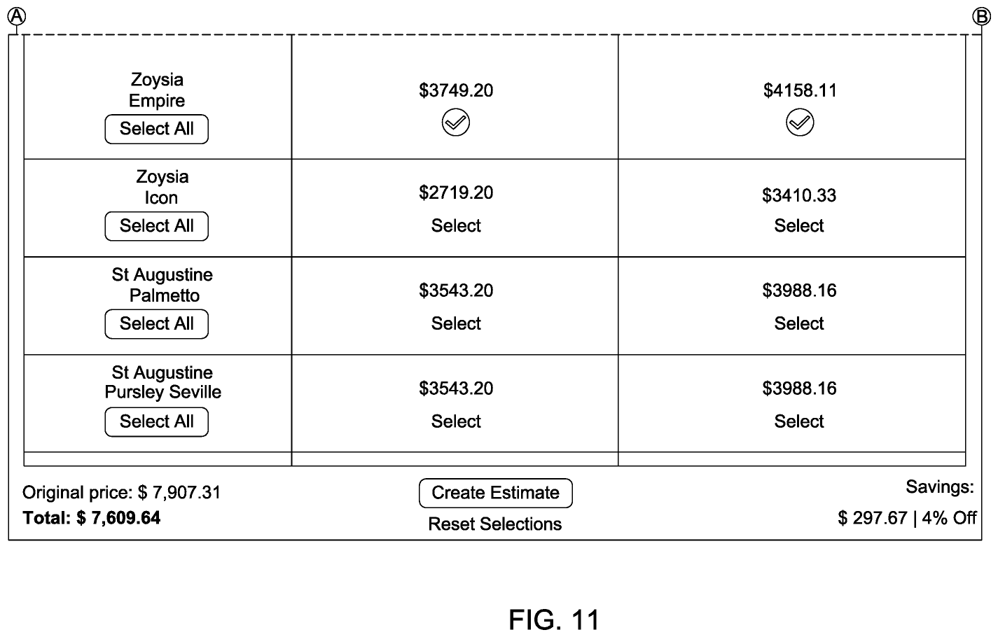

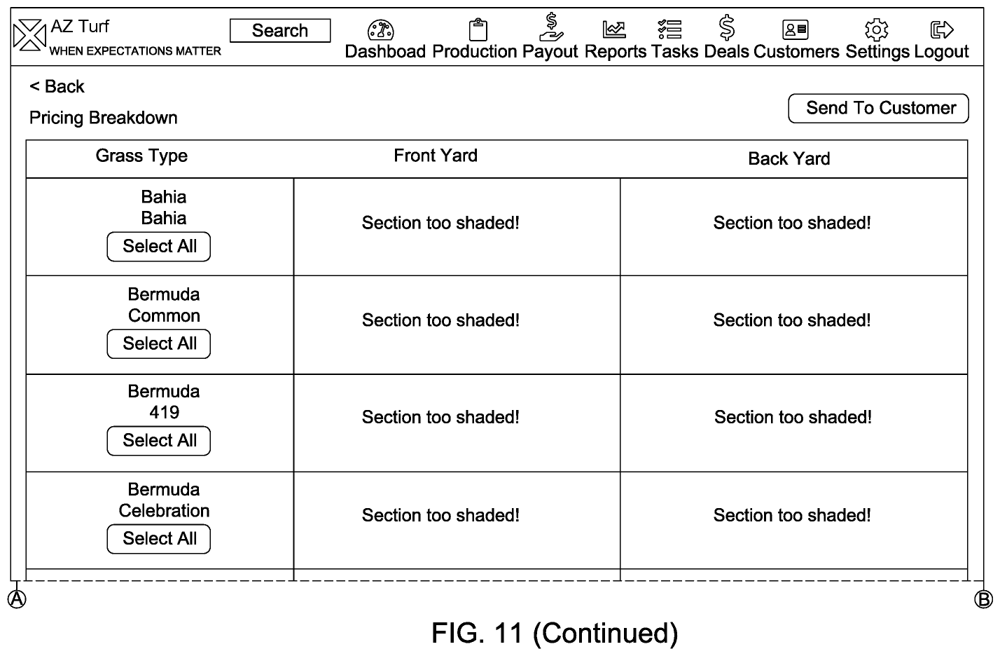

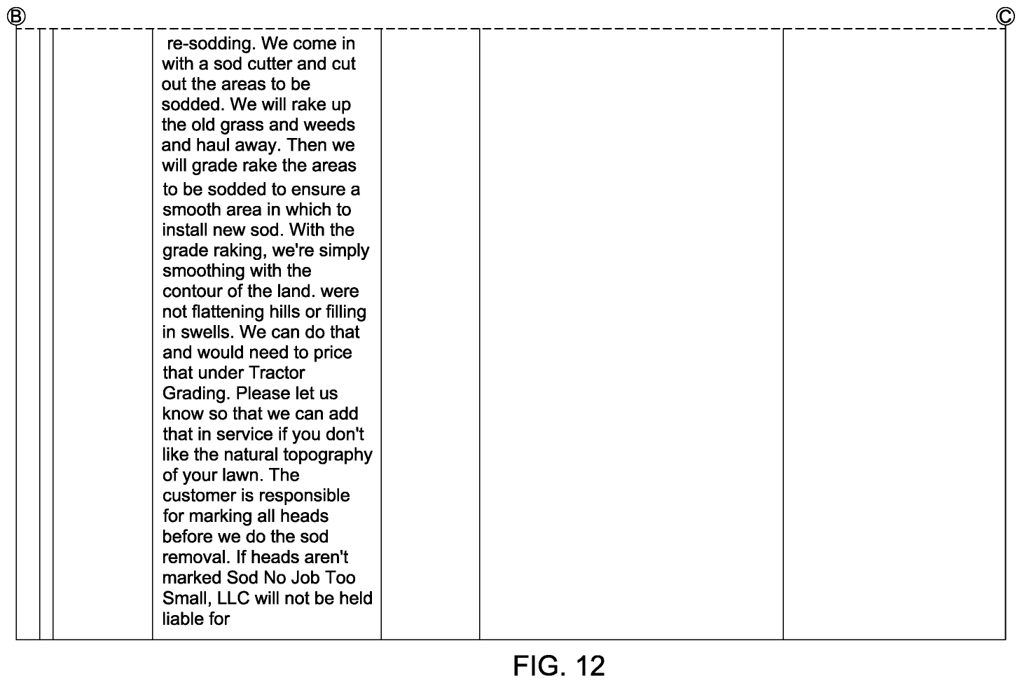

At 314, a pricing table is generated and displayed based on the sections and services selected for each section. The pricing table can show cost per section and can optionally include tiered pricing for each section where different tiers of products or services are available. An example pricing table is shown in FIG. 11 and described below. The pricing table can be generated based on one or more parameters such as minimum charge per section, referral fee, commission, card service fee, pallet inflation, minimum for a particular tier of service, fuel surcharge, unusual conditions, or other pricing parameters. Processing continues to 316.

At 316, an indication of selected services, and optionally tiers of service, are received. The selections can be received from input to the pricing table GUI. Processing continues to 318.

At 318, pricing (e.g., tiered pricing, etc.) for the project and any discounts applied are displayed. Processing continues to 320.

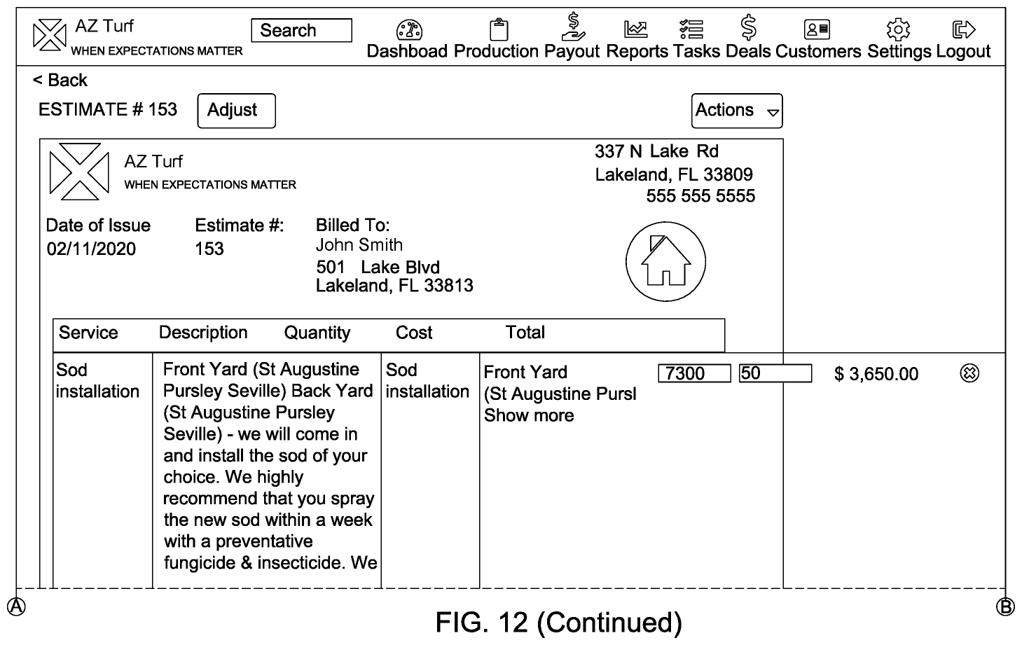

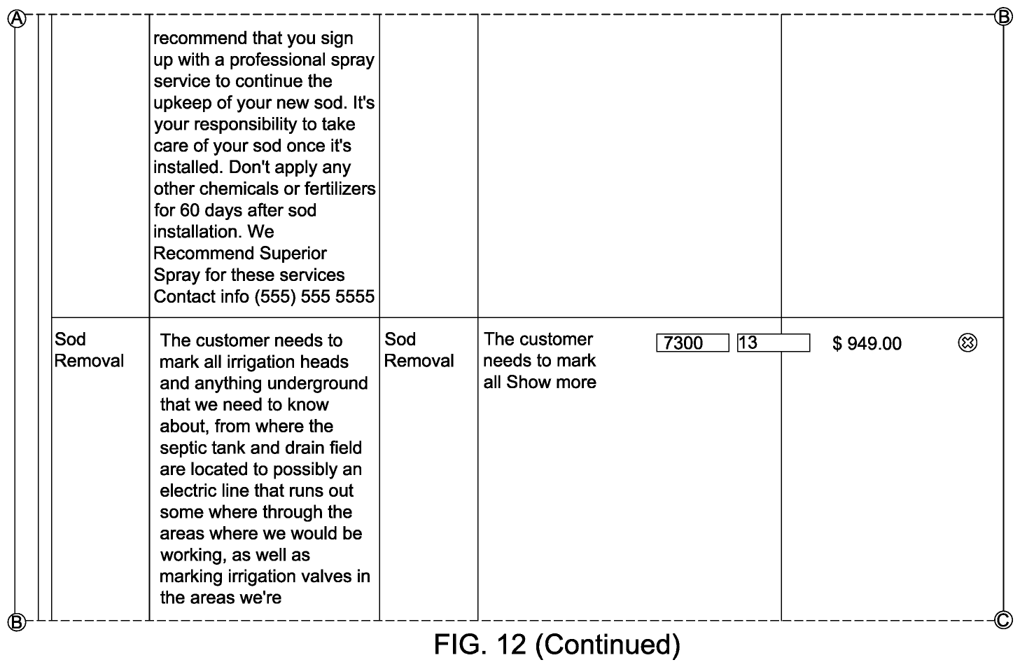

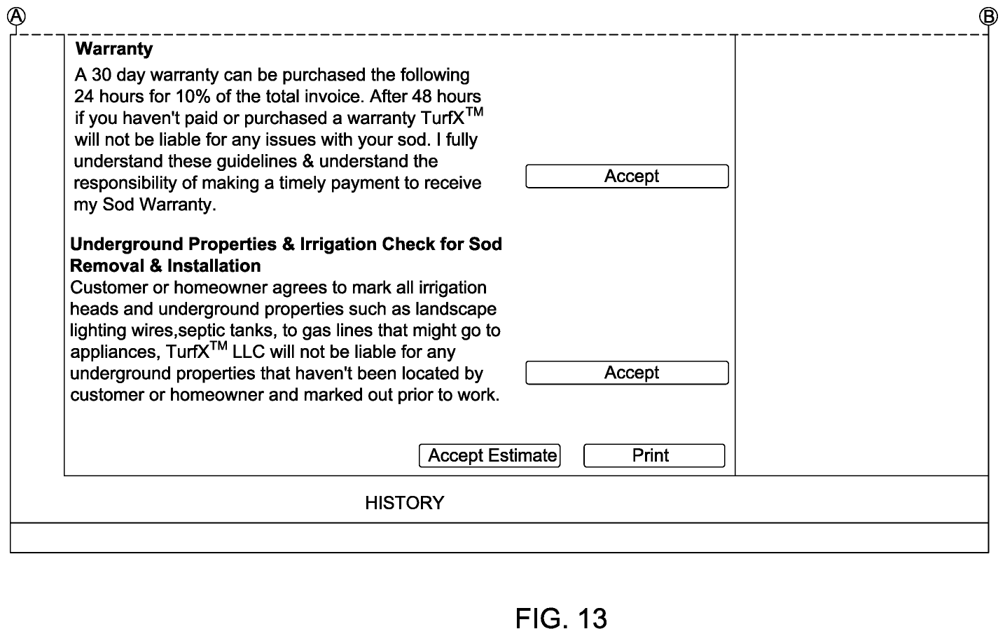

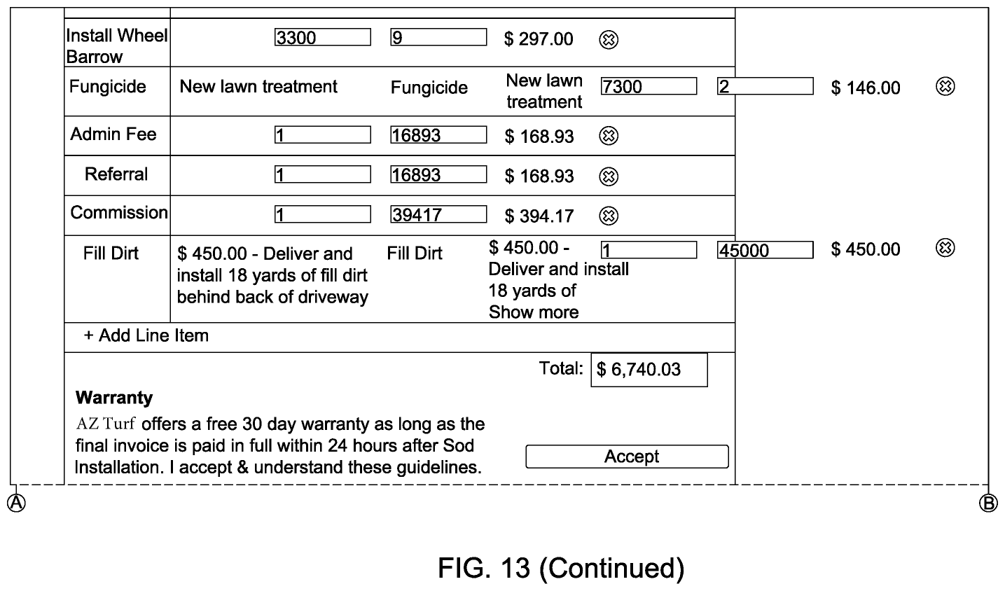

At 320, an estimate is generated based on selections from the pricing table. For example, an estimate can include line items for each service for each section of a project. An example estimate is shown in FIGS. 12 and 13 and described below. Processing continues to 322.

At 322, optionally, a sales commission, referral commissions, or other fees, such as credit card transaction fees can be displayed as line items of the estimate. Processing continues to 324.

At 324, the estimate is displayed. Processing continues to 326.

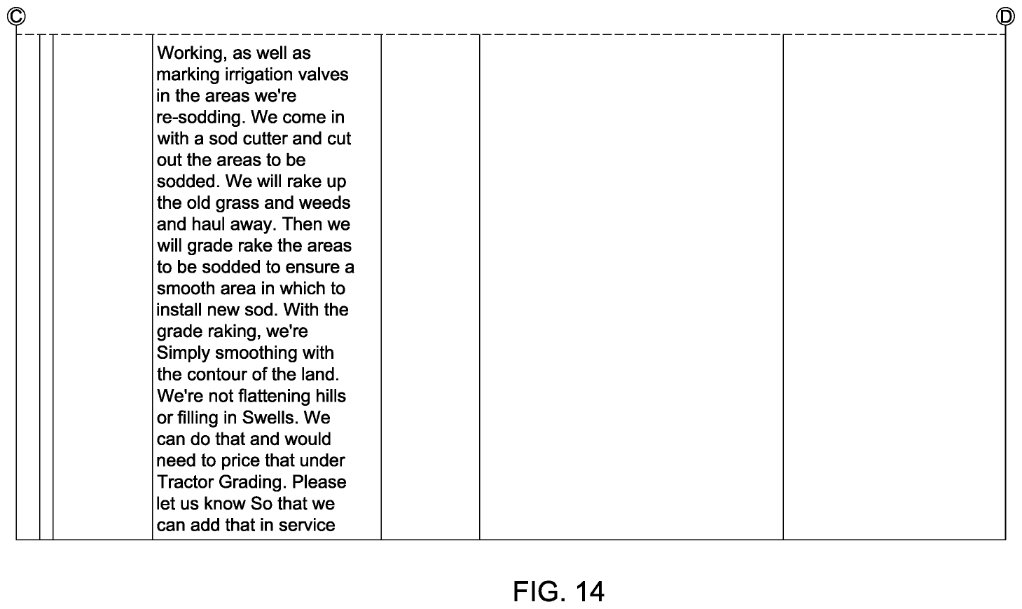

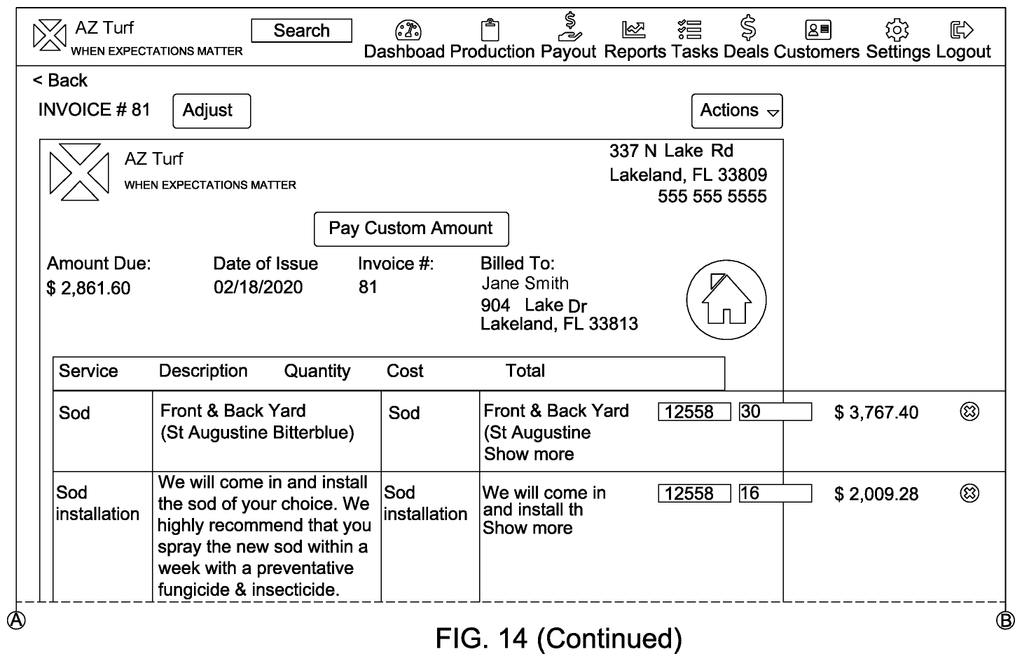

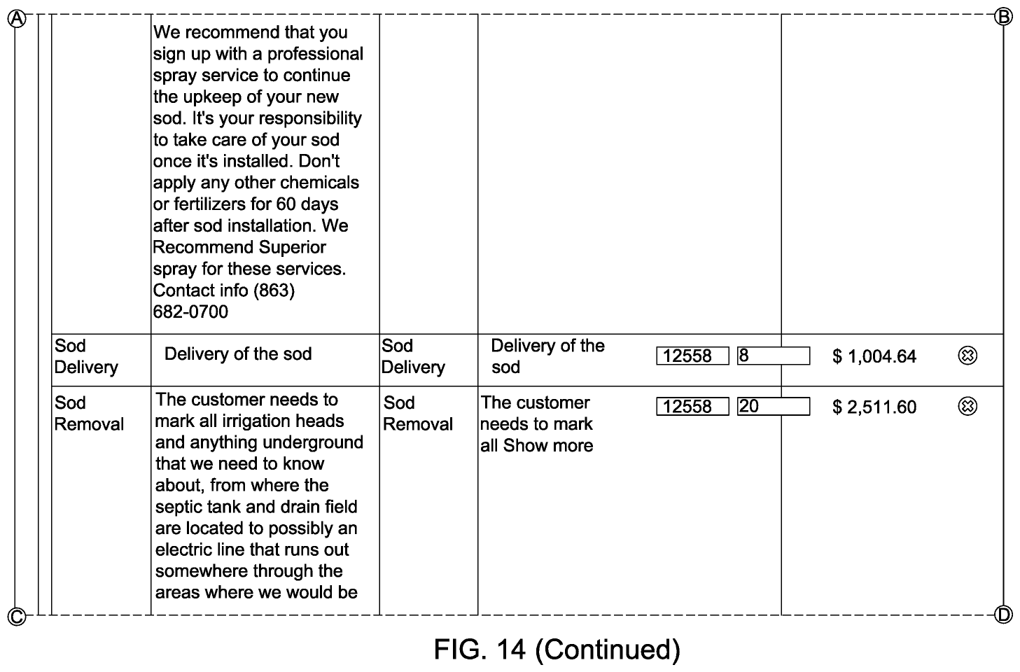

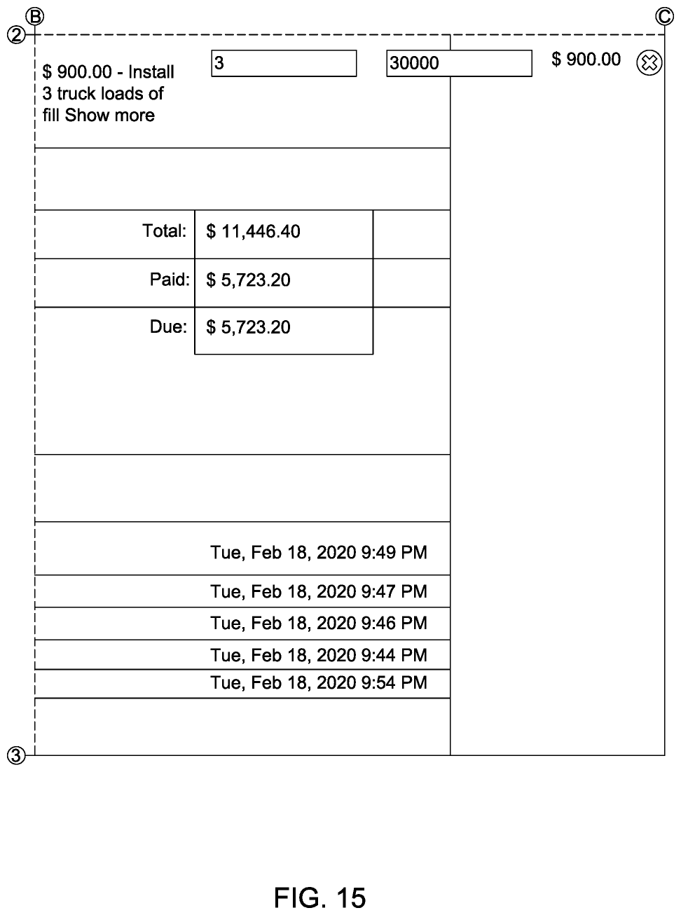

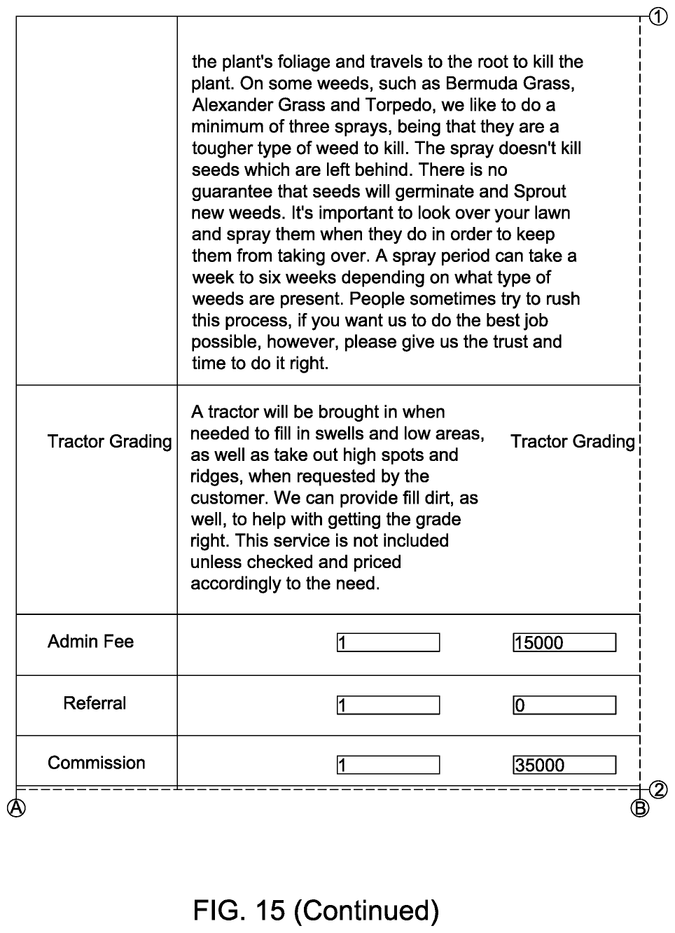

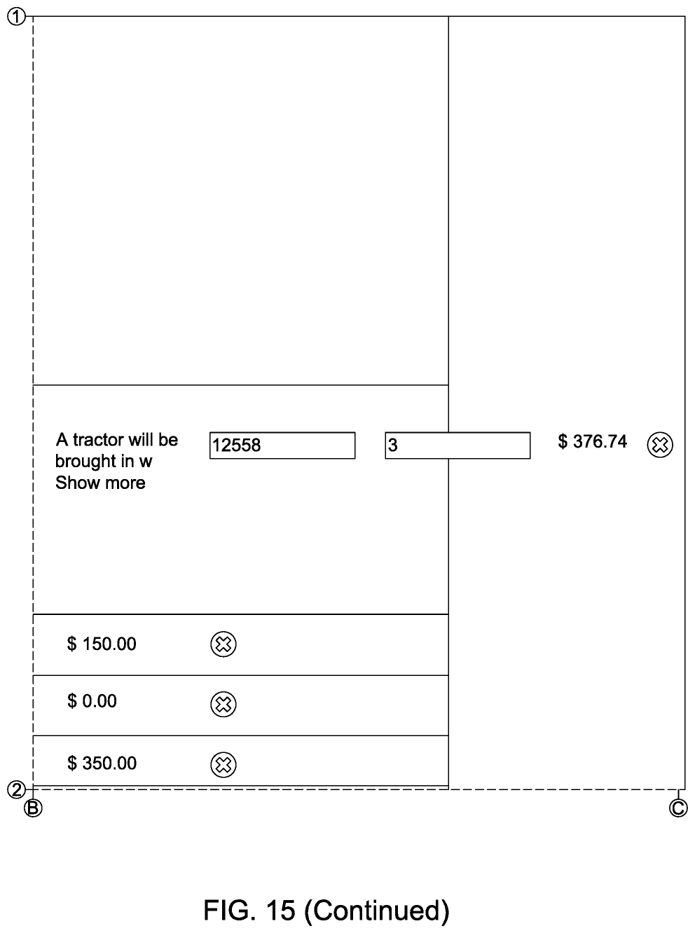

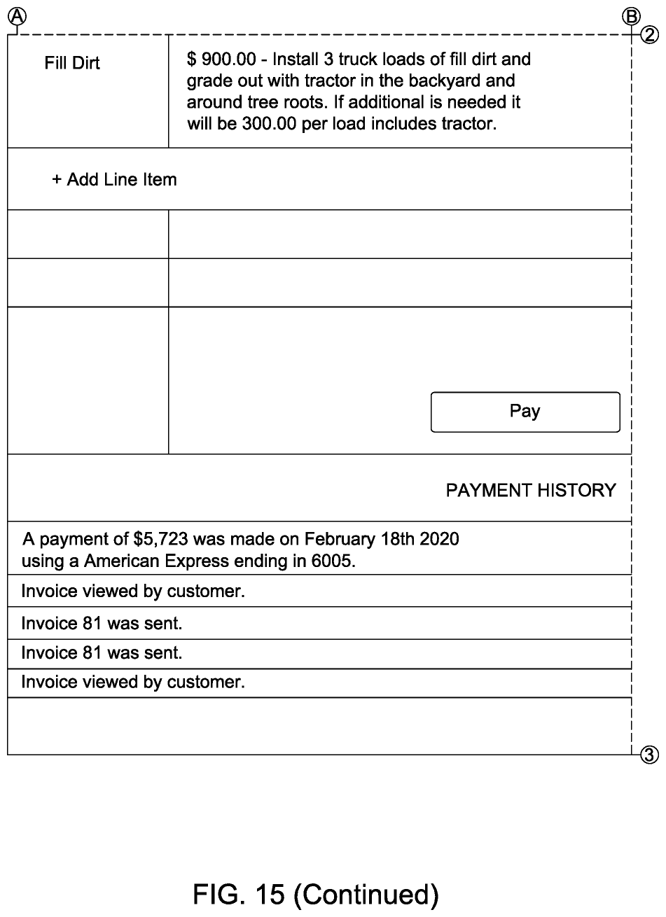

At 326, an indication of customer acceptance of the estimate is received. For example, the customer can indicate acceptance by selecting an element on a GUI, by electronically signing the estimate, etc. The estimate can be adjusted before acceptance by selecting or deselecting services, changing grass types in a section, changing tiers, and/or selecting or deselecting sections. Once the estimate is accepted, an invoice can be created from the estimate. An example of an invoice is shown in FIGS. 14 and 15 and described below. Processing continues to 328.

At 328, the project is moved to the production stage upon receipt of deposit payment for the invoice. The deposit may be a portion of the total project cost, the total project cost, or zero in some cases. Also, payouts for referral fees, commissions, and/or subcontractors can be scheduled upon receipt of the deposit.

In FIG. 3, various blocks (e.g., blocks 302-328) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

Block 312 of FIG. 3 describes optionally utilizing a probabilistic model (or other type of model as described below in conjunction with FIG. 23) to determine or predict measurements and services.

FIG. 4A is a flow diagram illustrating an example method 138 to manage a production process via the project management platform, according to some implementations.

In some implementations, method 138 can be implemented, for example, on a server system 102 as shown in FIG. 1A. In other implementations, some or all of the method 138 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 138.

Some implementations can initiate method 138 based on user input. A user may, for example, have selected the initiation of the method 138 from a displayed user interface. In some implementations, method 138 or portions thereof can be performed with guidance by the user via user input.

In some implementations, the method 138, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 138, and/or one or more other events or conditions occurring which can be specified in settings of a device implementing method 138. In some implementations, such conditions can be previously specified by a user in stored custom preferences of the user (accessible by a device or method with user consent).

The method begins at block 401, where one or more tasks are identified for each service in a project invoice. For example, prior to installing sod, an herbicide treatment, removal of dead grass, and leveling of the ground may be required for a selected service of installing new sod. For example, the herbicide treatment may require multiple tasks such as multiple herbicide applications separated by a given number of days. Processing continues to 402.

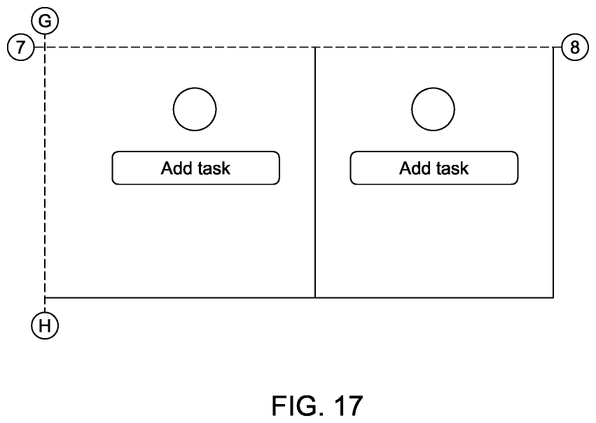

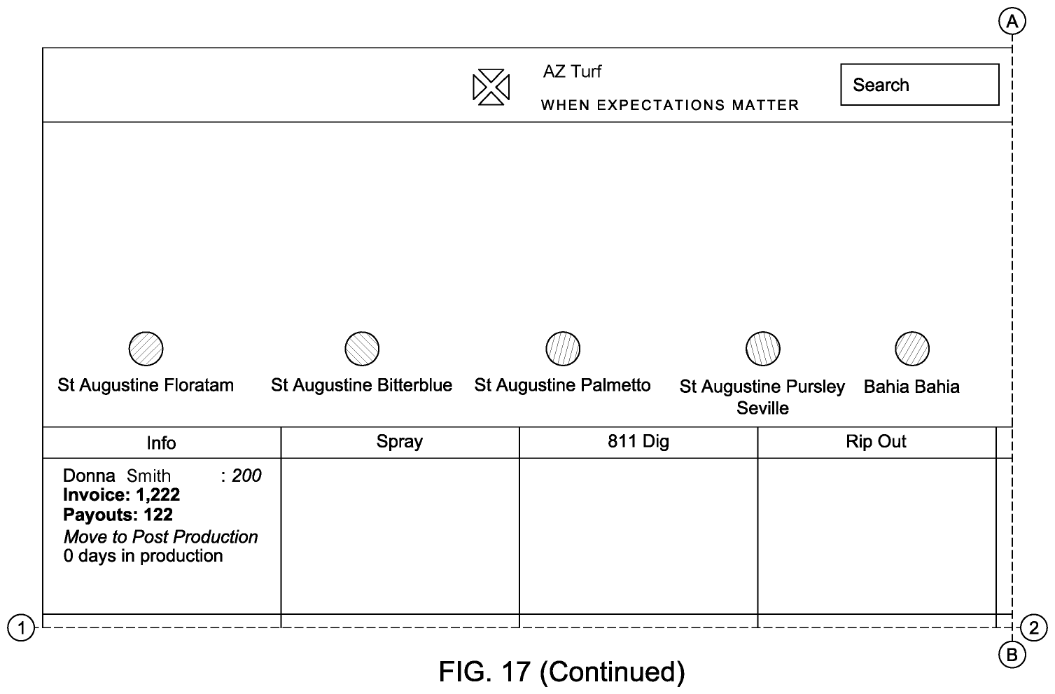

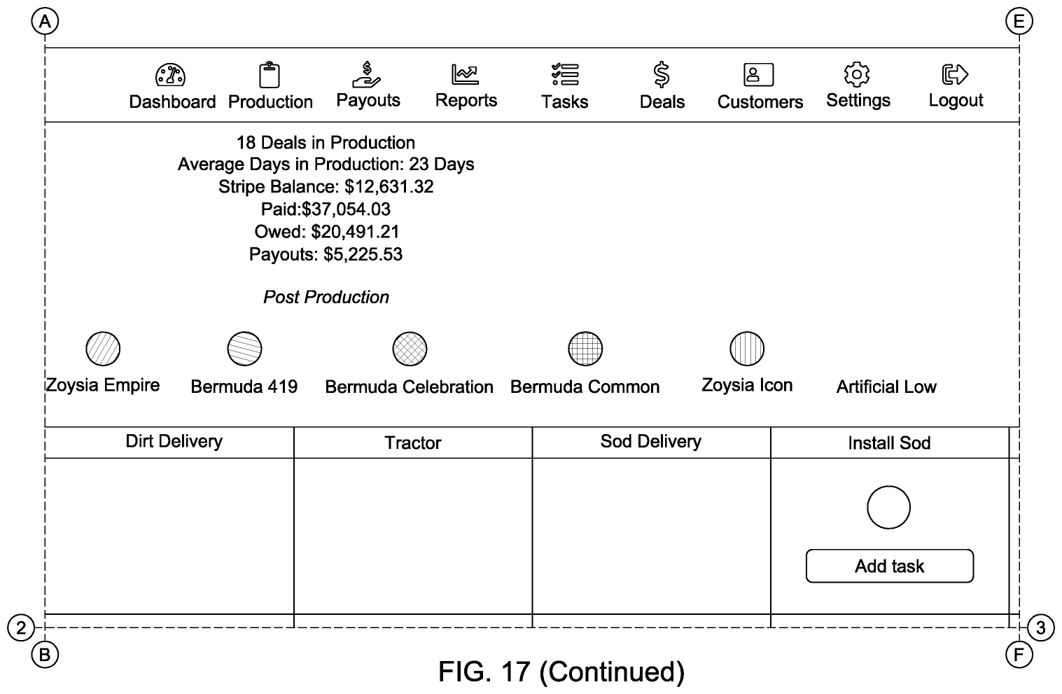

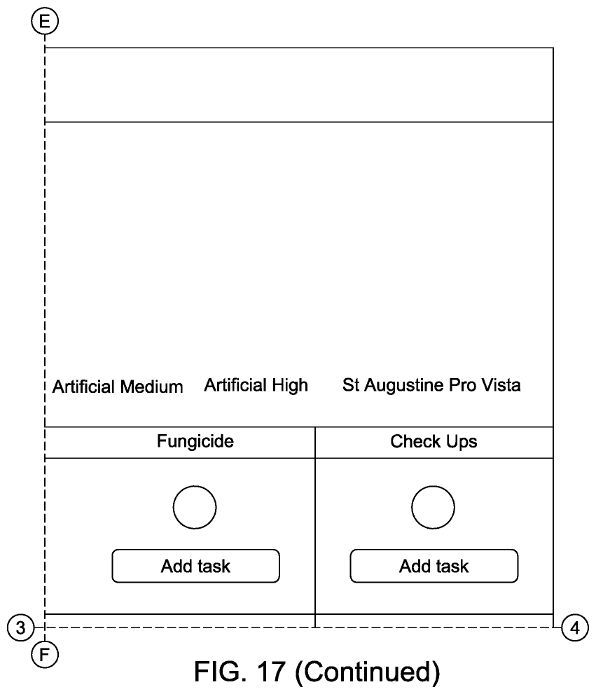

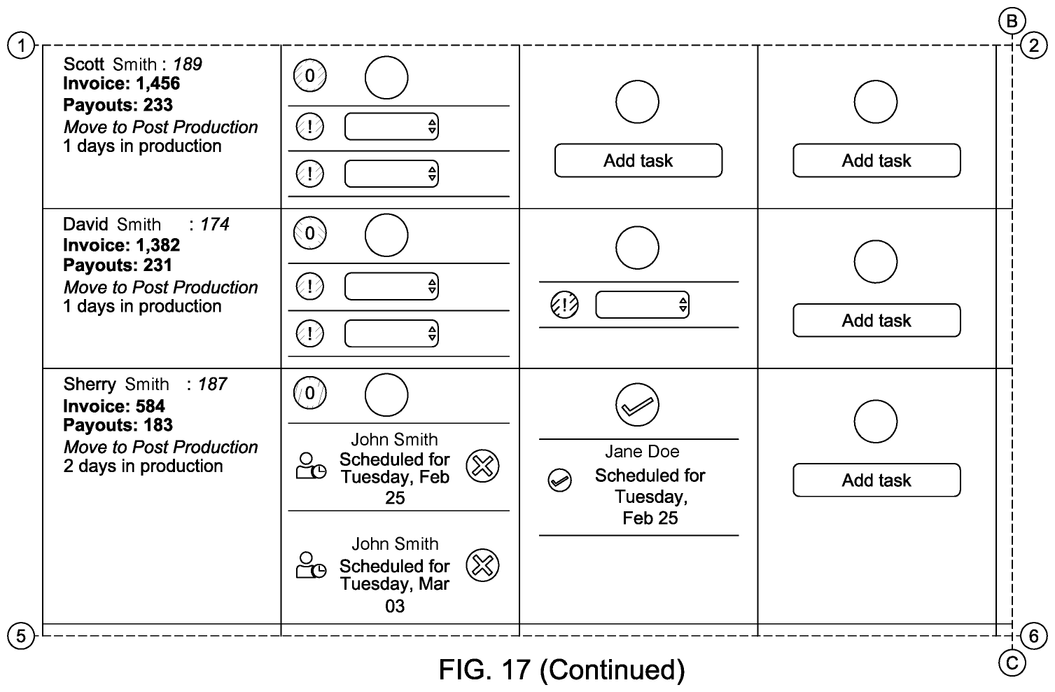

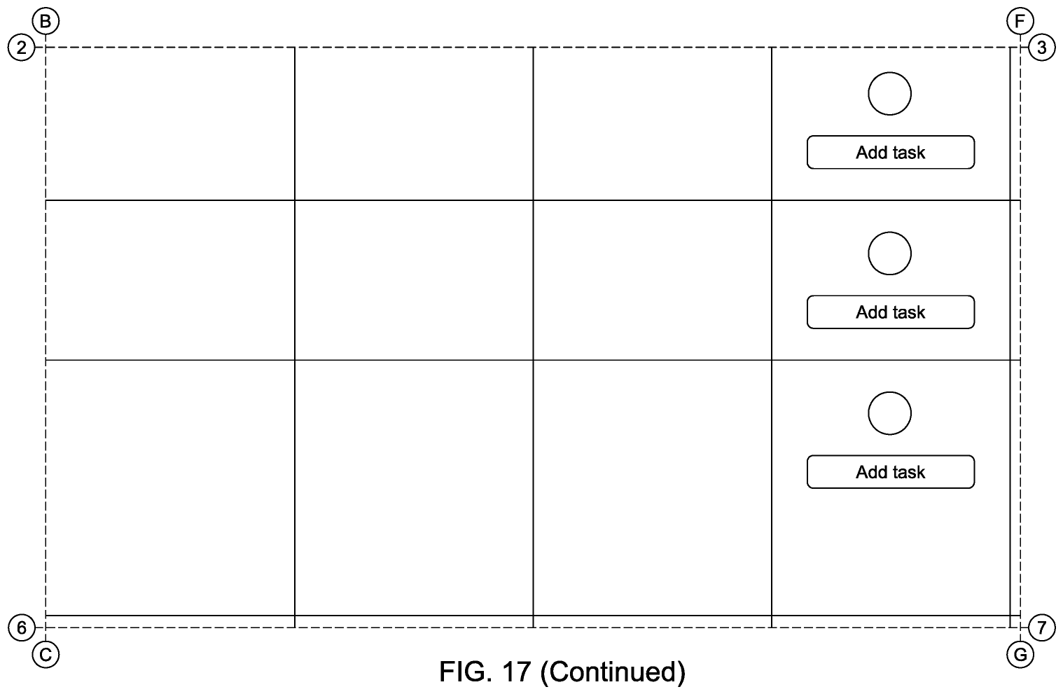

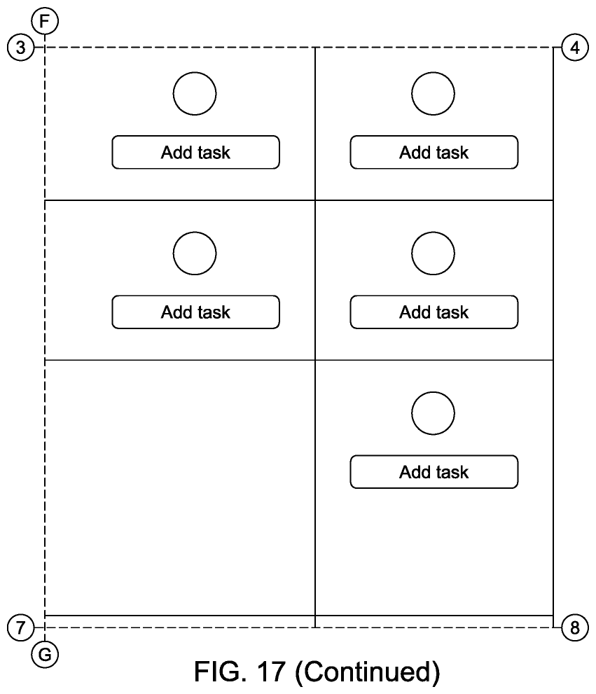

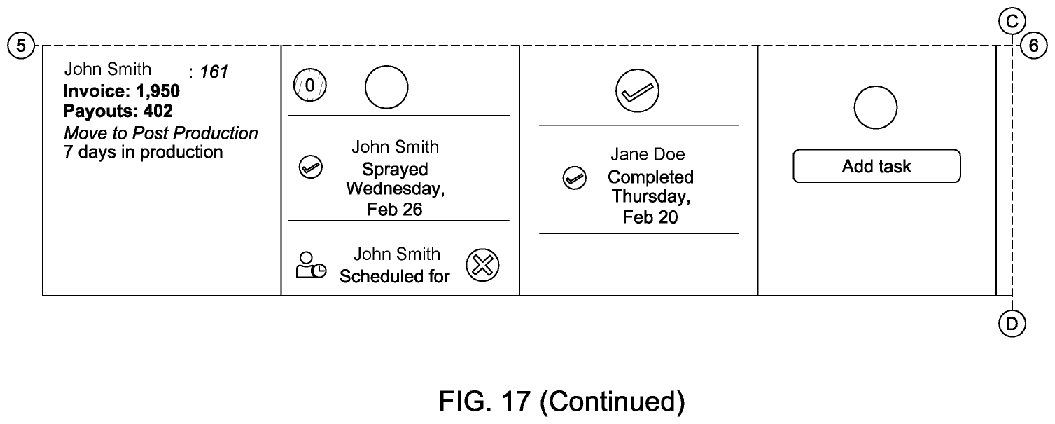

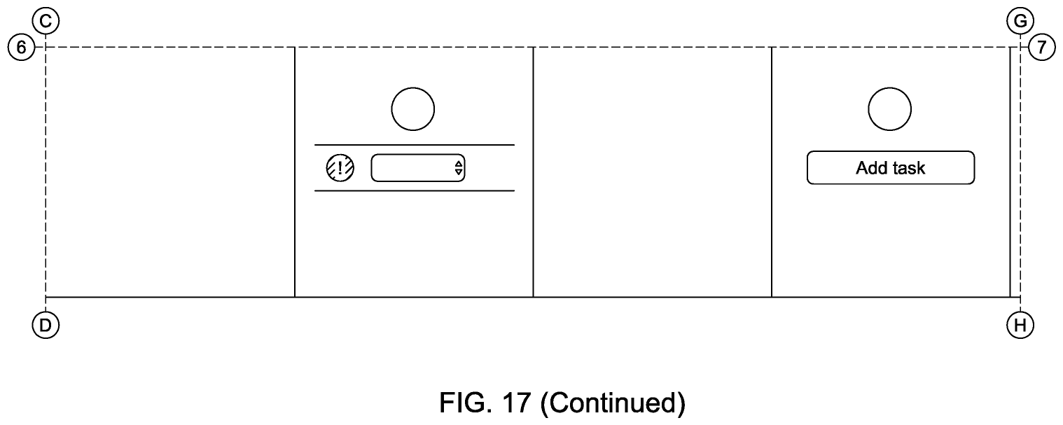

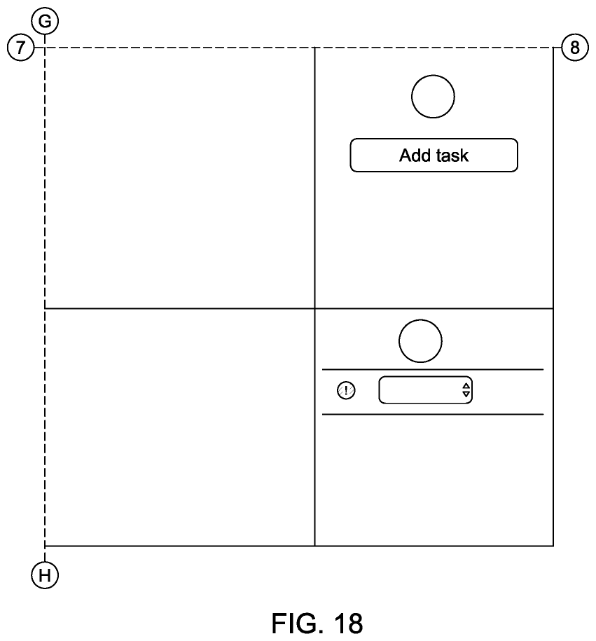

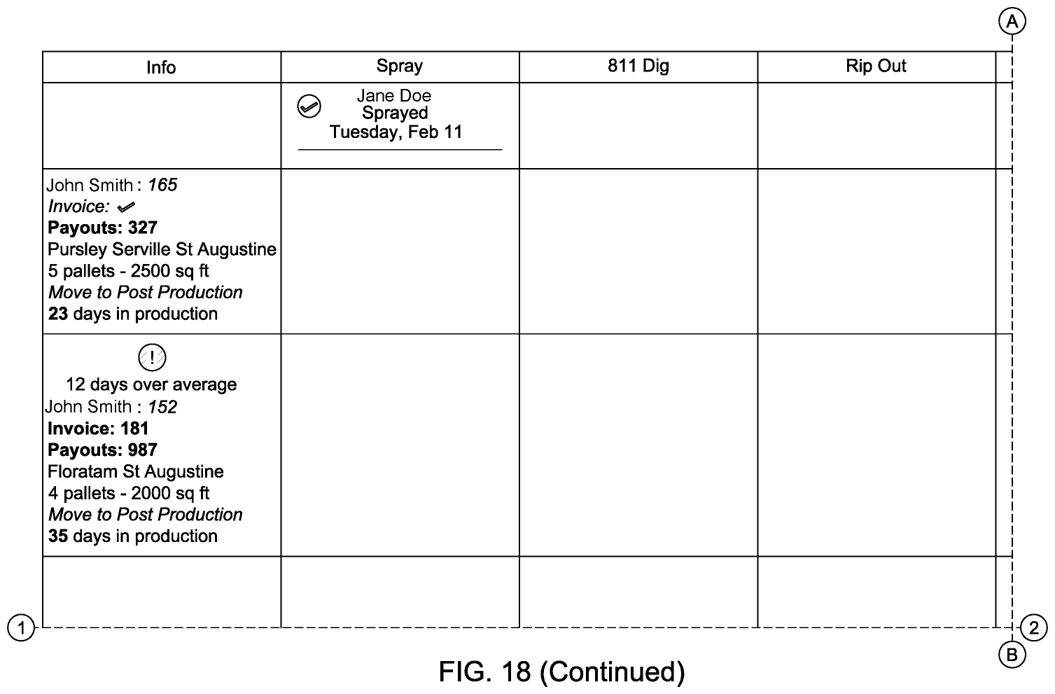

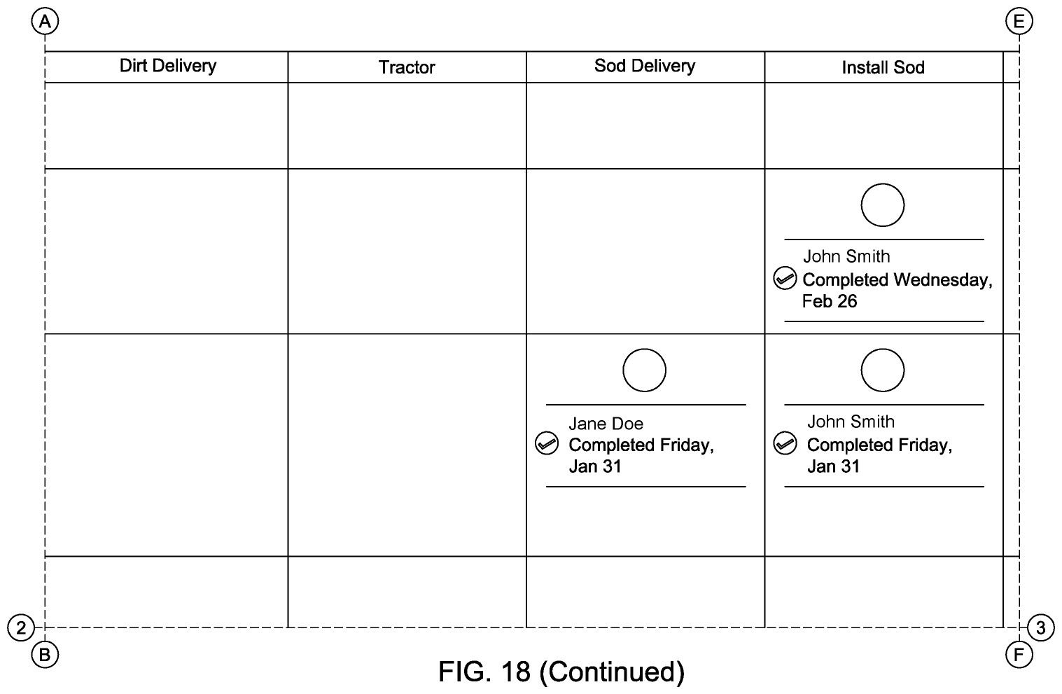

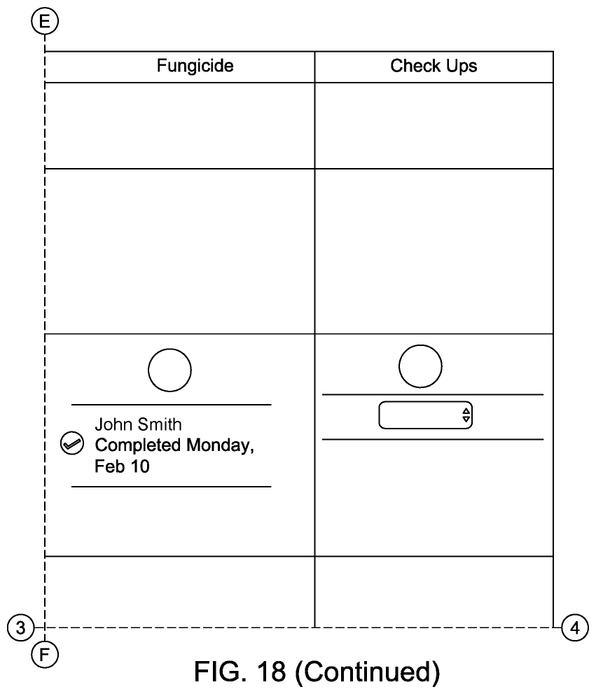

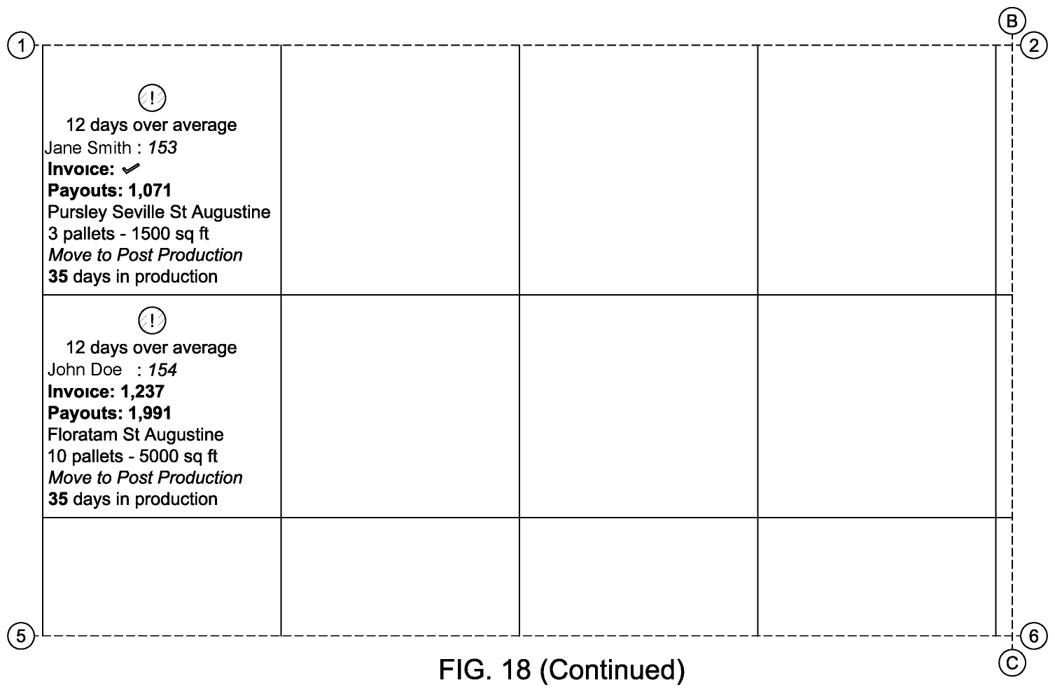

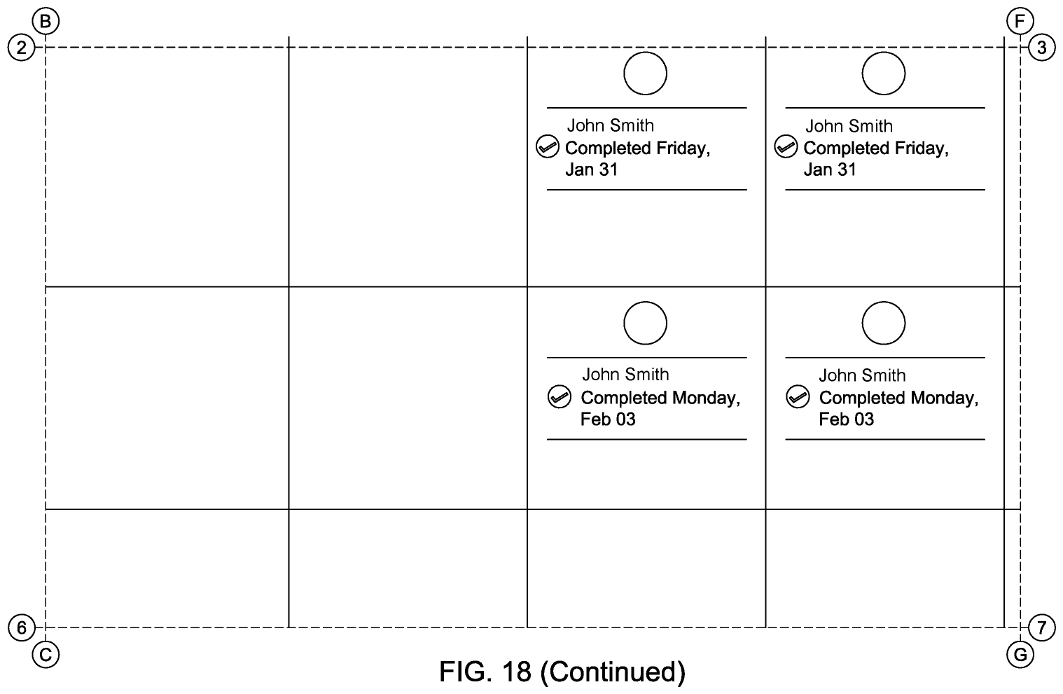

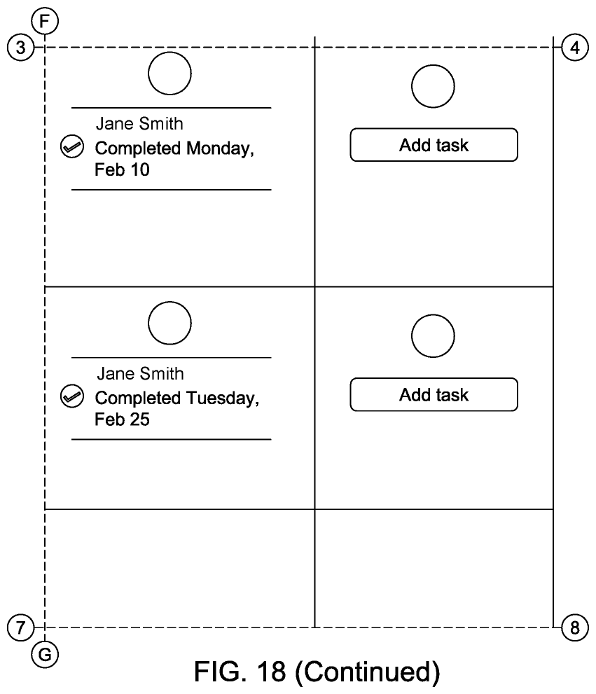

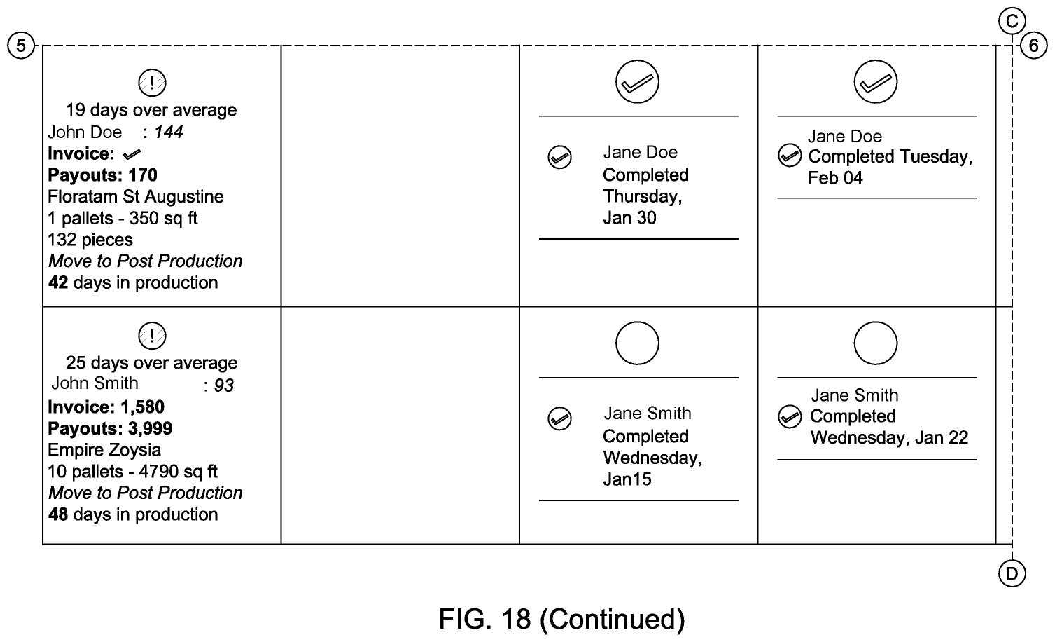

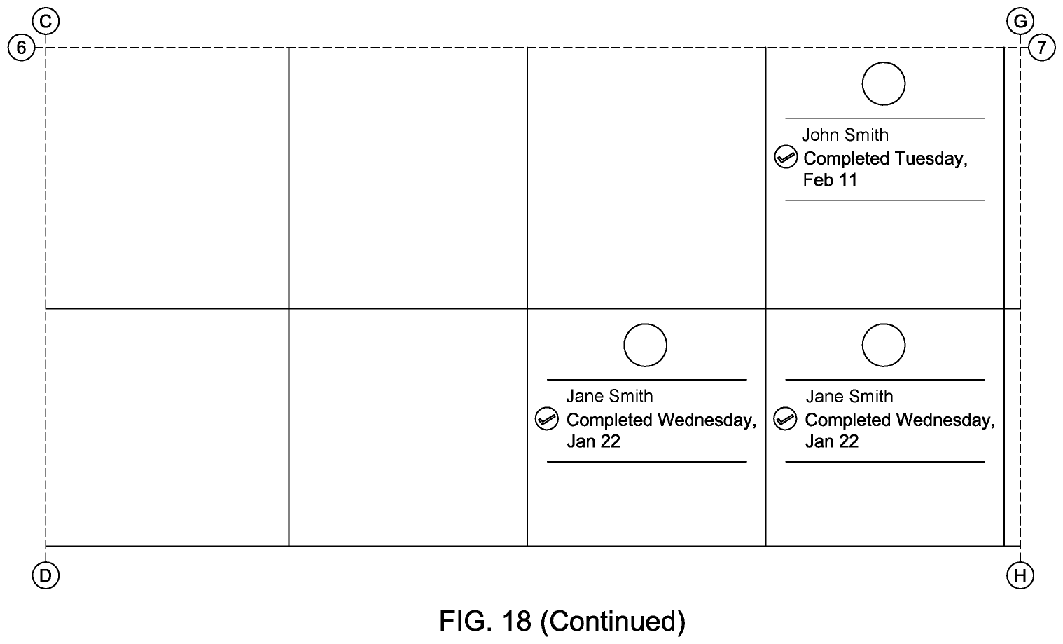

At 402, a production table entry is generated based on the tasks identified in block 401. The production table entry can be added to a production table (e.g., FIGS. 17 and 18). In some implementations, entries in the production table can include rows that represent projects and columns that represent tasks. Processing continues to 404.

At 404, the production table entry is displayed in a production table GUI (e.g., FIGS. 17 and 18). Processing continues to 406.

At 406, scheduling data for one or more tasks are received. For example, once the project and tasks are displayed in the production table, scheduling information for each task can be received from a GUI element of the production table (e.g., from user input) or determined programmatically based on electronic schedule information of subcontractors. For example, the project management platform can compare a new project task needs and start date with employee or subcontractor availability (e.g., via electronic calendar) to determine an available time for scheduling one or more tasks and automatically schedule those tasks. Processing continues to 408.

At 408, an electronic message is sent to each employee/subcontractor to inform employees/subcontractors corresponding to the tasks of the tasks and scheduling information for the tasks. The messages can include one or more of an email message, a text message or the like. Processing continues to 410.

At 410, an indication of task completion is received at the project management platform. For example, once an employee or subcontractor has completed a task, the employee/subcontractor can send an electronic message to the project management platform indicating task completion and optionally including electronic documentation of task completion such as digital pictures or video. In some implementations, employees and subcontractors may have a mobile application connected to the project management platform that permits the employee/subcontractor to indicate task completion and attach any evidence such as pictures or video. In some implementations, employees and subcontractors may access a website through a browser interface, where the website is connected to the project management platform and permits the employee/subcontractor to indicate task completion and attach any evidence such as pictures or video. Processing continues to 412.

At 412, a task completion approval process is performed. In some implementations, the task completion approval process can include a GUI that permits user review of the evidence (e.g., display of the digital pictures or video) of task completion and manual approval of the task completion via selection of a user interface element by the user. In some implementations, the task approval process can be an automated process as shown in FIG. 4B and described below. Processing continues to 414.

At 414, if task completion is approved (e.g., manually or automatically) the production table GUI is updated to reflect the completion of the task. If the task completion is not approved (e.g., manually or automatically), the employee/subcontractor responsible for the task is notified via electronic message including an indication that task completion was not approved, the issue preventing approval of task completion and a request that the issue with the task be addressed.

In FIG. 4A, various blocks (e.g., blocks 401-414) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

As shown in FIG. 4B and described below, block 412 of FIG. 4A optionally utilizes a probabilistic model (or other type of model as described below in conjunction with FIG. 23) to determine or predict completion of a production task.

FIG. 4B is a flow diagram illustrating details of an example task approval process 412, according to some implementations. The process begins at 416, where electronic task completion evidence (e.g., digital pictures, videos, etc.) are received at the project management platform. The evidence can be received along with an indication from an employee/subcontractor that the task is complete (e.g., via mobile application connected to the project management platform or via a website interface such as a browser interface). Processing continues to 418.

At 418, the evidence (e.g., digital images or videos) are analyzed either manually or automatically. For example, in a manual review process, the project management platform can cause the evidence to be displayed to a user for task completion approval and the user can review the evidence and approve or disapprove the task completion.

In the automated evidence review process, a task completion review module of the project management platform, such as a machine learning model, can receive the task completion evidence as input and analyze the evidence based on the machine learning model trained to evaluate evidence for task completion. Processing continues to 420.

At 420, the project management platform can determine whether the task was completed based on the analysis by the task completion review module. Processing continues to 422.

At 422, if the task is complete processing continues to 424. Otherwise, processing continues to 426.

At 424, the task status is set to complete and the production table GUI can be updated accordingly.

At 426, the task status is set to incomplete. Once a task is set to complete, a payout (if applicable) for that task can be scheduled. For example, if a task is being performed by a subcontractor and the task is indicated as complete, a payout for the agreed upon price for the subcontractor to perform that task can be automatically scheduled. Processing continues to 428.

At 428, responsible parties for the task (e.g., employee/contractor, supervisor, salesperson, etc.) can be notified electronically (e.g., via email, text message, etc.) of incomplete status and a follow up for completion can be requested.

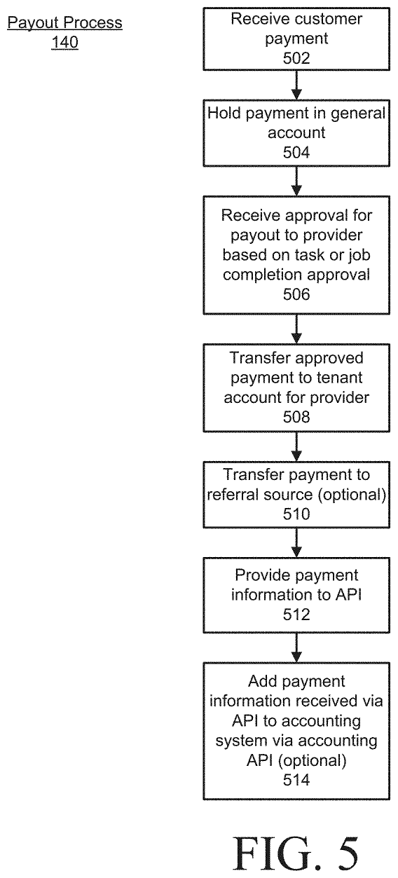

FIG. 5 is a flow diagram illustrating an example method 140 for payout processing via the project management platform, according to some implementations.

In some implementations, method 140 can be implemented, for example, on a server system 102 as shown in FIG. 1A. In other implementations, some or all of the method 140 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 140.

Some implementations can initiate method 140 based on user input. A user may, for example, have selected the initiation of the method 140 from a displayed user interface. In some implementations, method 140 or portions thereof can be performed with guidance by the user via user input.

In some implementations, the method 140, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 140, and/or one or more other events or conditions occurring which can be specified in settings of a device implementing method 140. In some implementations, such conditions can be previously specified by a user in stored custom preferences of the user (accessible by a device or method with user consent).

The method begins at block 502, where an electronic customer payment is received. For example, the customer payment can be an electronic credit card or bank payment for a project deposit or a project final payment. Processing continues to 504.

At 504, the customer payment is held in an electronic general account. Processing continues to 506.

At 506, approval is received for a scheduled payout to a service provider (e.g., employee or subcontractor) based on approval of task or job completion (e.g., as described above in connection with FIGS. 4A or 4B). Processing continues to 508.

At 508, an electronic transfer for the payout is approved and made from the electronic general account to a tenant account associated with the service provider (e.g., employee or subcontractor). Processing continues to 510.

At 510, a payment is transferred from the electronic general account to an electronic tenant account of the referral source for a referral fee (if any) and/or to a salesperson for commission (if any). Processing continues to 512.

At 512, the payment information (e.g., from 508 and/or 510) is transferred to a payment processor via an API. Processing continues to 514.

At 514, payment information received via the API with the payment processor is received and added to an accounting system via an accounting system API.

In FIG. 5, various blocks (e.g., blocks 502-514) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 6 is a flow diagram illustrating an example method 142 to onboard product or service providers or referral agents via the project management platform, according to some implementations.

In some implementations, method 142 can be implemented, for example, on a server system 102 as shown in FIG. 1A. In other implementations, some or all of the method 142 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 142.

Some implementations can initiate method 142 based on user input. A user may, for example, have selected the initiation of the method 142 from a displayed user interface. In some implementations, method 142 or portions thereof can be performed with guidance by the user via user input.

In some implementations, the method 142, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 142, and/or one or more other events or conditions occurring which can be specified in settings of a device implementing method 142. In some implementations, such conditions can be previously specified by a user in stored custom preferences of the user (accessible by a device or method with user consent).

The method begins at block 602, where a prospective service provider (e.g., subcontractor) or referral source (e.g., agent, influencer, other referral source) send a text message to a given number (e.g., a subcontractor/referral agent sign up number) connected to the project management platform (e.g., the cloud communication platform 202 connected to the project management platform server 204). Processing continues to 604.

At 604, the project management platform (e.g., via the cloud communications platform) transmits a URL to a number that the text was received from (e.g., the mobile number of the prospective service provider or referral source). In some implementations, the URL can be a URL to a web page for onboarding a service provider or referral source. Processing continues to 606.

At 606, the project management platform receives a connection request at the URL from the subcontractor/referral source device. Processing continues to 608.

At 608, the project management platform responds to the connection request with a subcontractor/referral source sign up form. Processing continues to 610.

At 610, the project management platform receives the subcontractor/referral source sign up data electronically (e.g., from a GUI in the sign-up form). The sign-up data can include name, address, tax identification, phone number, email address, etc. Processing continues to 611.

At 611, a subcontractor/referral source database record is created including an auto-generated telephone number (e.g., 210 in FIG. 2) that is associated with the subcontractor/referral source in the project management platform. Processing continues to 612.

At 612, a payout card number is optionally received from the subcontractor/referral source. For example, as part of the onboarding process prospective subcontractors or referral agents can be given a payment card (e.g., a Visa or Mastercard card or the like) that can be branded (e.g., with the branding information of the project management platform operator or user). The payment card can include a card number. Processing continues to 614.

At 614, the card number received at the project management platform at block 612 is linked (or associated with) the record for the subcontractor or referral agent. By associating the card number with the subcontractor or referral agent, the project management platform can make payouts or payments to the card number for the subcontractor or referral agent corresponding to the payout.

In FIG. 6, various blocks (e.g., blocks 602-614) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIGS. 7-19 show example graphical user interfaces of a project management platform configured for a sod business. This is an example implementation of the systems and methods described herein. The project management platform can be arranged and configured for any industry or organization where management of projects, including multi-phase, multi-participant projects need to be managed.

FIG. 7 is an example GUI showing a pre-measurement checklist for a project. The pre-measurement checklist is a checklist to help ensure that certain information or steps have been taken prior to commencement of measurement (when needed for a project) or other pre-estimate process begins. The pre-measurement checklist GUI can include a plurality of steps (e.g., Steps 1-5 as shown), where each step includes one or more user interface elements such as radio buttons, text input boxes, etc. for gathering the pre-measurement checklist information. As shown in FIG. 7, the information gathered at each step includes: presence of sprinkler system (step 1), number of sprinklers (step 2), confirmation of zones checked and sprinklers marked (step 3), irrigation repair scheduled (step 4), and job (or project) start date (step 5).

FIG. 8 is an example GUI showing a project sections interface that provides user interface elements to add a section to a project. For example, in a sod business project, a section can include an area of a yard or grounds (e.g., a front yard, a back yard, a side yard, etc.). In another example, in a roofing business project, a section can include an area of a roof.

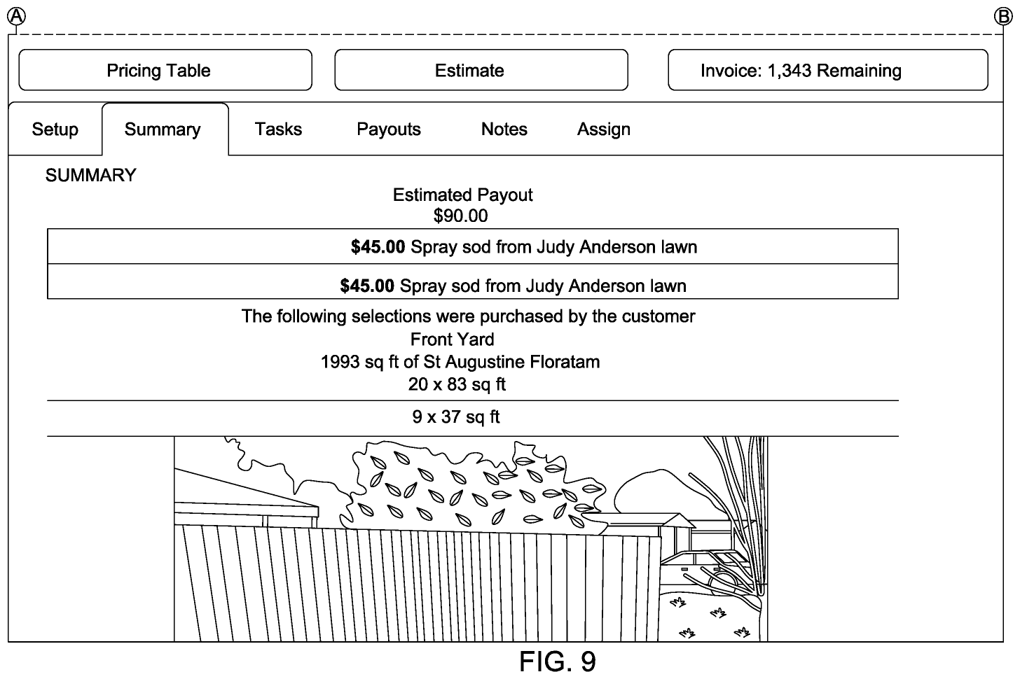

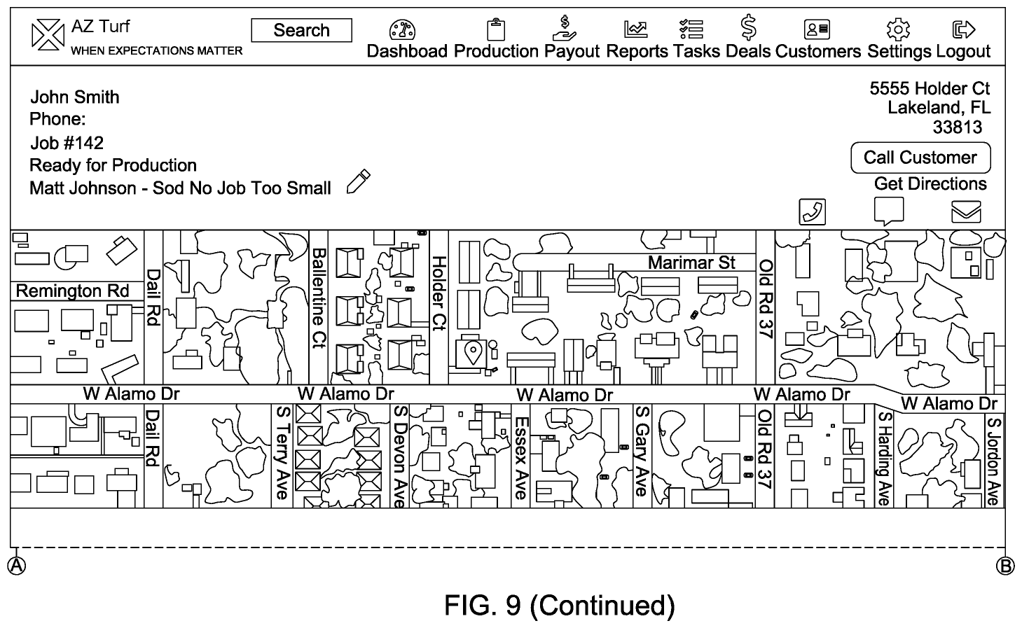

FIG. 9 is an example GUI showing a project sections summary listing the sections that are currently in a project (also referred to as a job or deal in the example GUIs). FIG. 9 shows an example section of a front yard.

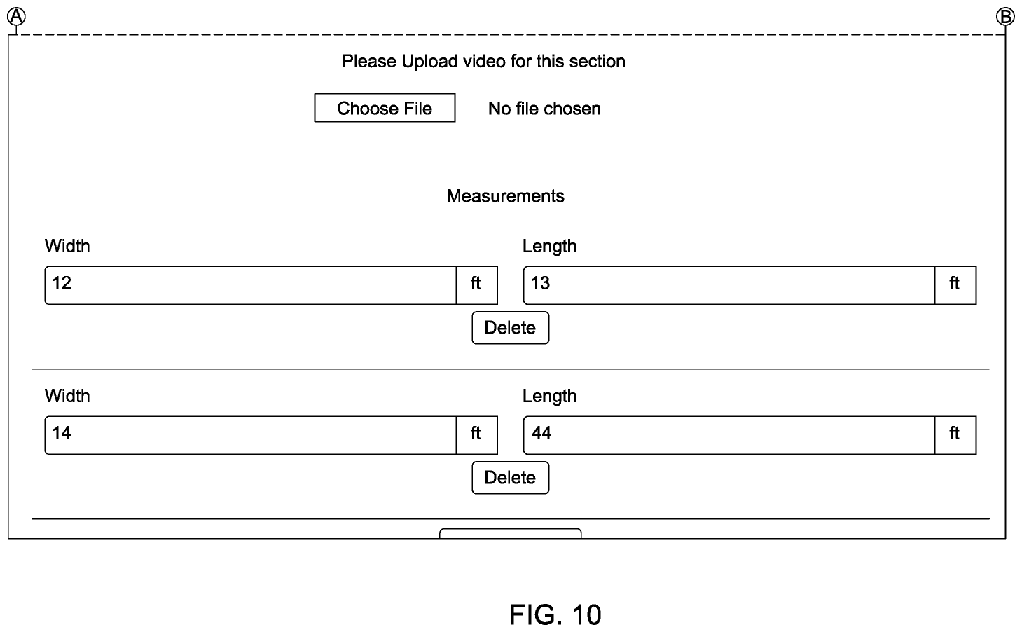

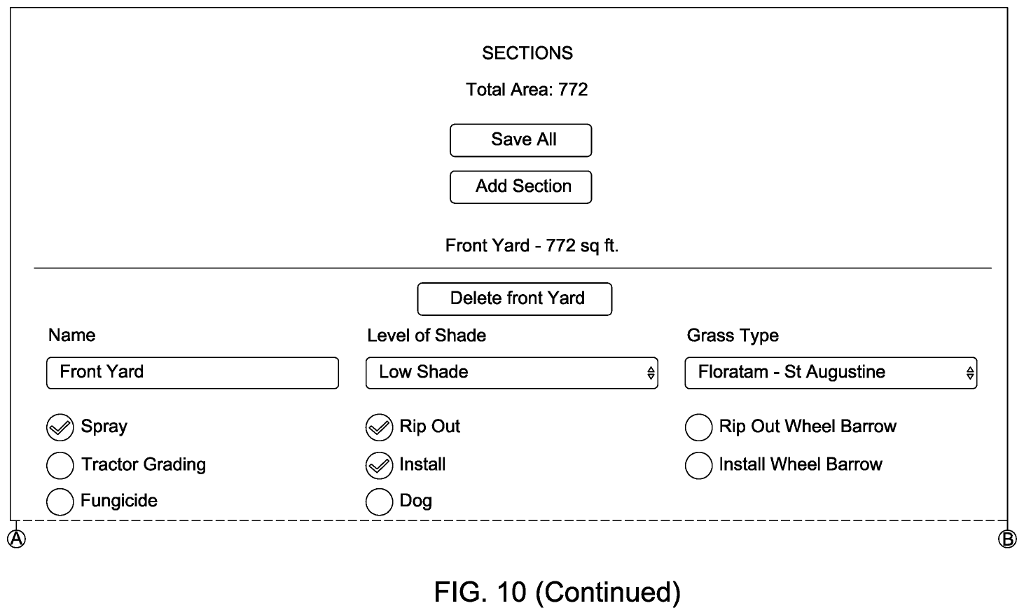

FIG. 10 is an example GUI showing project section builder detail to input details of a section of a project. As shown in FIG. 10, the example section details can include one or more of: section name, level of shade, grass type, services selected (e.g., spray, rip out, tractor grading, install, fungicide, dog, rip out wheel barrow, and install wheel barrow). The services are specific to the sod business example use case. Other products or services can be configured on a section builder GUI based on the industry an implementation is configured for. The section builder also includes user interface elements to enter dimensions of the section (e.g., one or more pairs of width/length dimensions). The user interface can also include an element to upload a video (or photos) to show the current conditions of the section.

FIG. 11 is an example GUI showing a pricing table for a project. The pricing table shows those options (e.g., grass types) available for selection based on the details input to the section builder GUI. For example, for a given shade level of a section, only certain grasses may be available because those may be the only recommended or viable options (e.g., Zoysia or St. Augustine as shown in FIG. 11). When an option is selected from the pricing table (e.g., Zoysia Empire) the price is updated automatically. When the option selection is changed, the pricing will be updated automatically based on the newly selected options. A savings amount can be shown. An estimate can be generated once the options selections are finalized by selecting the Create Estimate user interface element.

FIGS. 12 and 13 show an example GUI for a project estimate. The GUI can include line items with details such as one or more of a service name, description, quantity, cost, line item total, and/or a line delete element. The estimate GUI can also include an element to add a line item. The estimate GUI can also include one or more elements to accept terms of the estimate (e.g., warranty, waivers, etc.). The estimate GUI can also include elements to accept the estimate and to print the estimate. Once an estimate is accepted, an invoice can be generated by the project management platform.

FIGS. 14 and 15 show an example GUI for a project invoice that can include user interface elements for the line items from the accepted estimate including one or more of a service (or product), a description, a quantity, a unit cost, a total for the line, and/or a line delete element. The invoice GUI can also include a user interface element to make a custom payment amount. The invoice GUI can also include an element to add a line item. The invoice GUI can further include an element to pay the invoice (or a deposit on the invoice). The invoice GUI can also include a payment history section showing any payments made against the invoice.

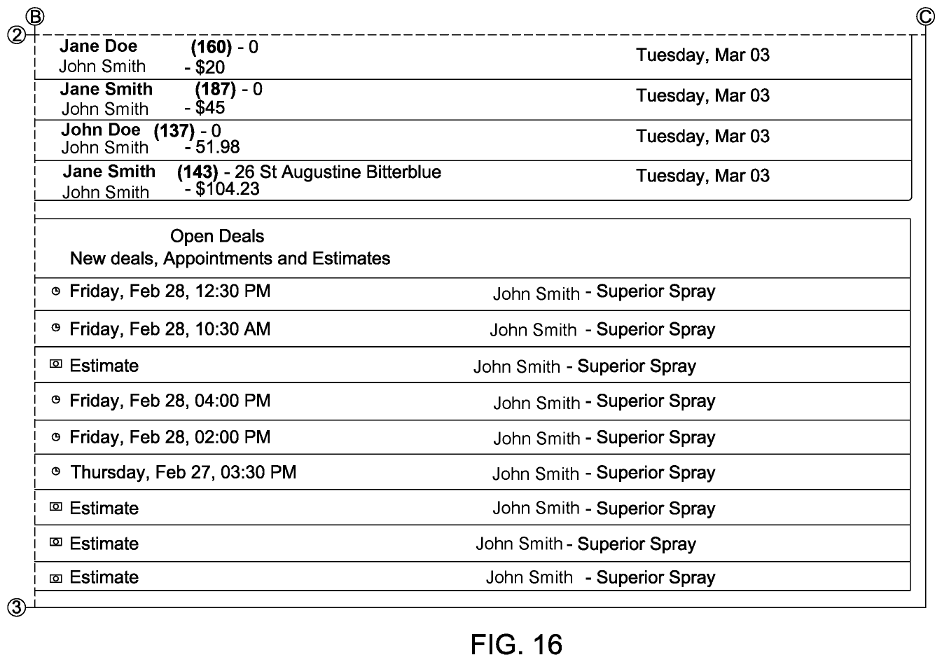

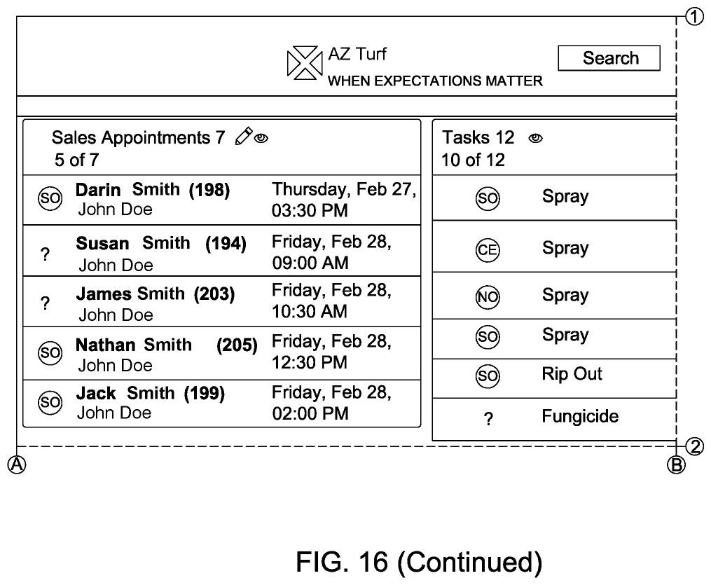

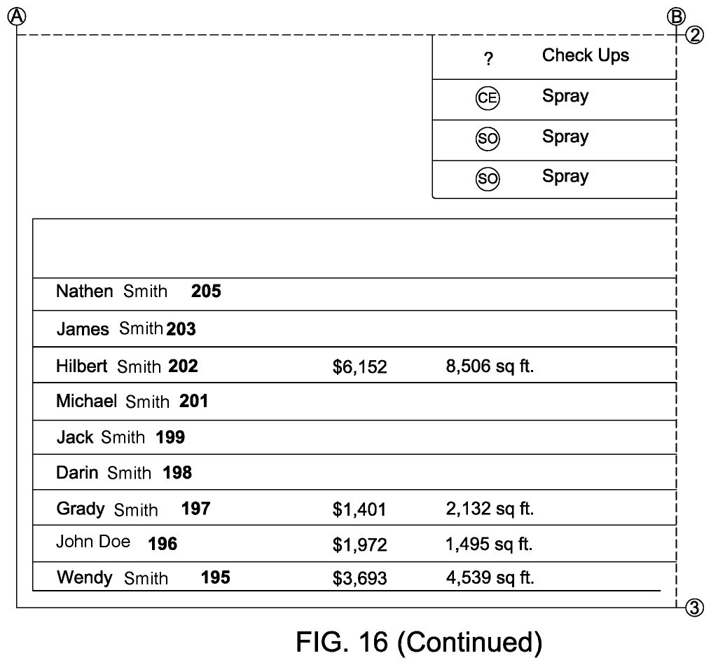

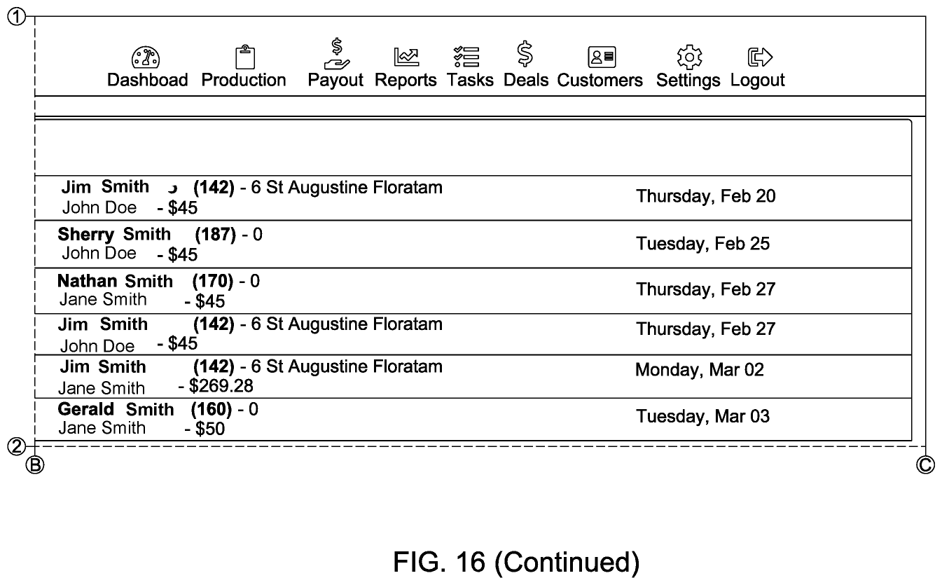

FIG. 16 is an example GUI showing a dashboard displaying sales appointments, subcontractor tasks, and open deals. The sales appointment section can show user interface elements for one or more of a color coded indication (or other indication) of a zone of a sales appointment (e.g., green for north, yellow for central and red for south), a prospect name, a project (or deal or job) number, a sales person name, and/or a date and time. The tasks section can show one or more task line items that can each include one or more user interface elements such as a color coded indication (or other indication) of a zone of the project location, a service description (e.g., spray, etc.), customer name, deal number, subcontractor name, subcontract amount, and/or planned date of completion (which can be color coded to indicate when a service date is imminent (e.g., with yellow) or past due (e.g., with red)).

The open deals section can include one or more lines each representing a deal. Each deal line can include one or more user interface elements such as customer name, deal number, deal total value, deal square footage, sales appointment date, estimate link, and/or referral source.

FIGS. 17 and 18 show an example GUI of a project management production chart. The production chart can include one or more user interface elements such as number of deals (or projects) in production, average number of days a job is in production, electronic payment account balance, amount received for jobs in production, amount owed for jobs in production, and/or payouts made for jobs in production.

The production chart can also include one or more user interface element lines corresponding to deals (or projects) in production. Each line item can include one or more user interface elements such as customer information (e.g., one or more of customer name, deal number, invoice amount, payout amount, move to post production, and/or days in production) and one or more columns for services (e.g., spray, call 811 for digging information, rip out, dirt delivery, tractor work, sod delivery, install sod, fungicide, and/or checkup). The service columns can include color coded zone indicator, subcontractor, and/or date of completion. The service columns of a line can also include a user interface element to add a task to the service column within a line.

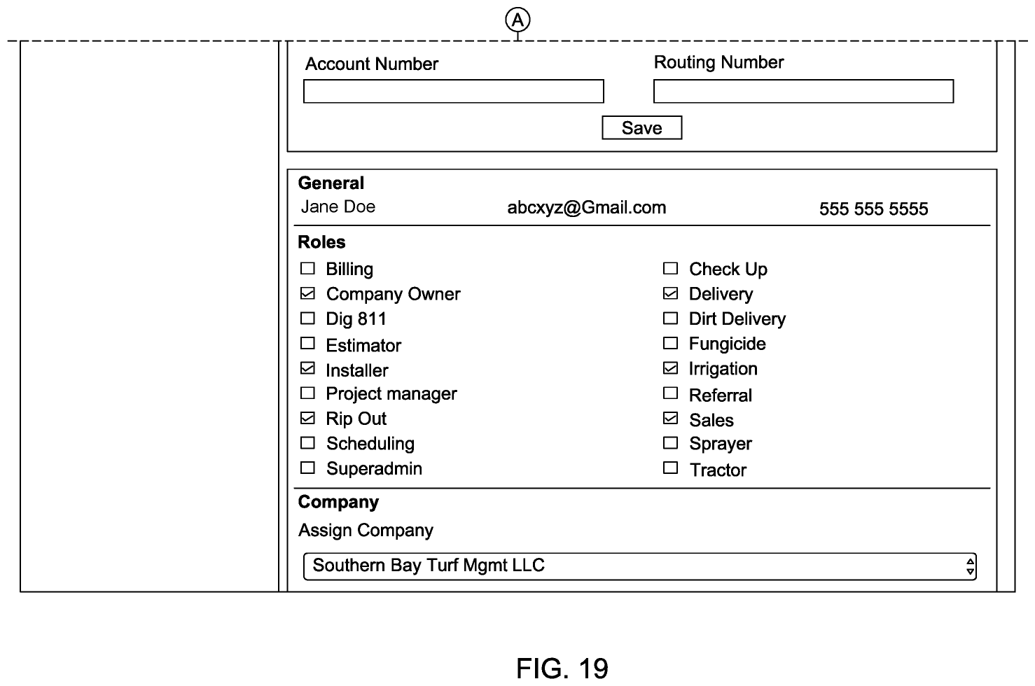

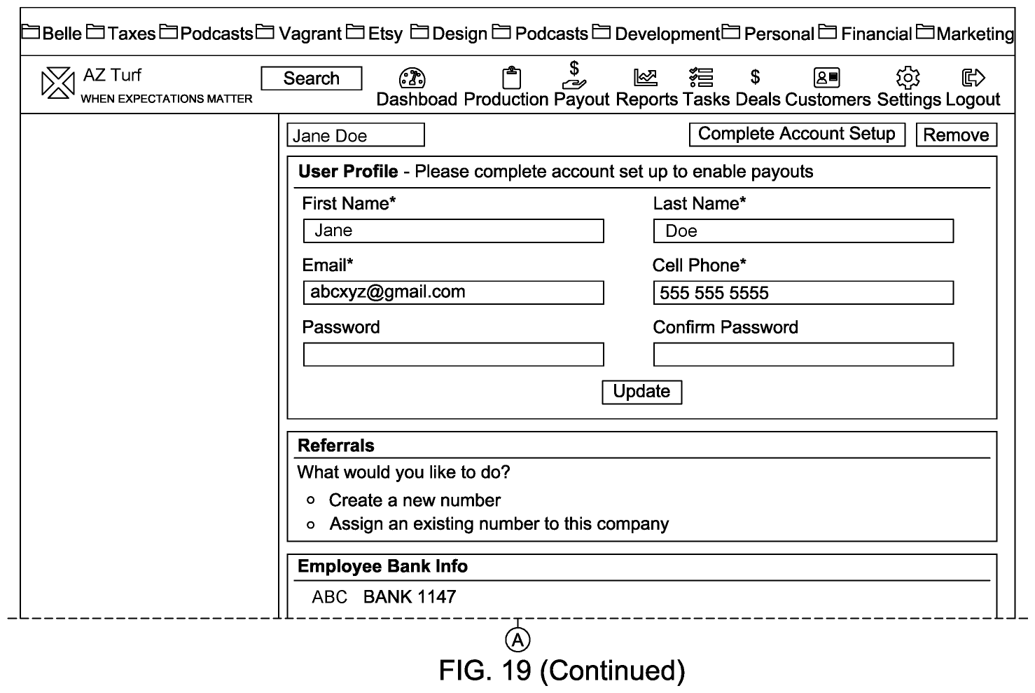

FIG. 19 is an example GUI showing a subcontractor (or referral agent) onboarding screen. The onboarding GUI can include a user interface element to select the type of entity being onboarded (e.g., user such as referral agent, subcontractor company, grass farm, or other services). As shown in FIG. 19, the onboarding GUI for a user includes user interface elements to complete account setup (e.g., once all required user information has been entered) or remove draft user onboarding information.

The onboarding GUI can also include user interface elements to enter or edit user profile information including one or more of first name, last name, email address, cell phone, and/or password and confirm password. The onboarding GUI can also include a selection to create a new referral ID or assign an existing referral ID in the project management platform to this user. The onboarding GUI can further include user interface elements to input or edit bank information for payouts. In some implementations, the onboarding GUI can include a user interface element to enter a card number (e.g., of a branded payment card) that can be linked to the user account in the project management platform and payouts can be sent to this payment card, which can be linked to a tenant account of an electronic payment account.

For subcontractor onboarding, the onboarding GUI can also include a section for general information input or editing such as roles (e.g., services provided), contact information, and company name.

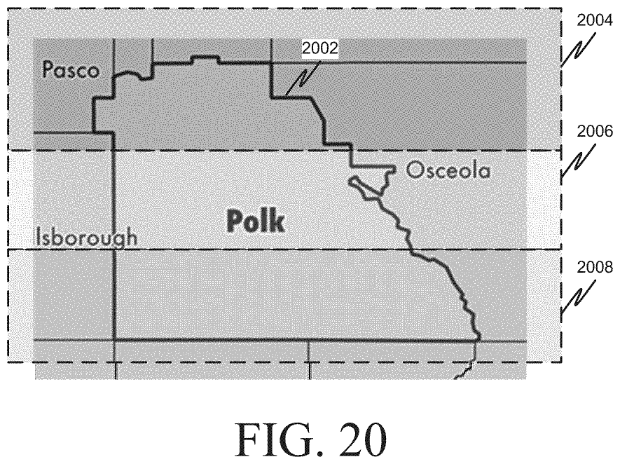

FIG. 20 is a diagram of an example geographic area 2002 divided into three zones: north 2004, central 2006, and south 2008. The zones can be defined by a user of the project management platform and can be color coded (e.g., red for north, yellow for central and green for south) on GUIs of the project management platform to give an easily ascertained visual indication of project location to a user of the project management platform. Appointments, projects and/or tasks can be color coded in one or more GUIs of the project management platform or associated web pages or mobile applications according to a zone system as shown in FIG. 20.

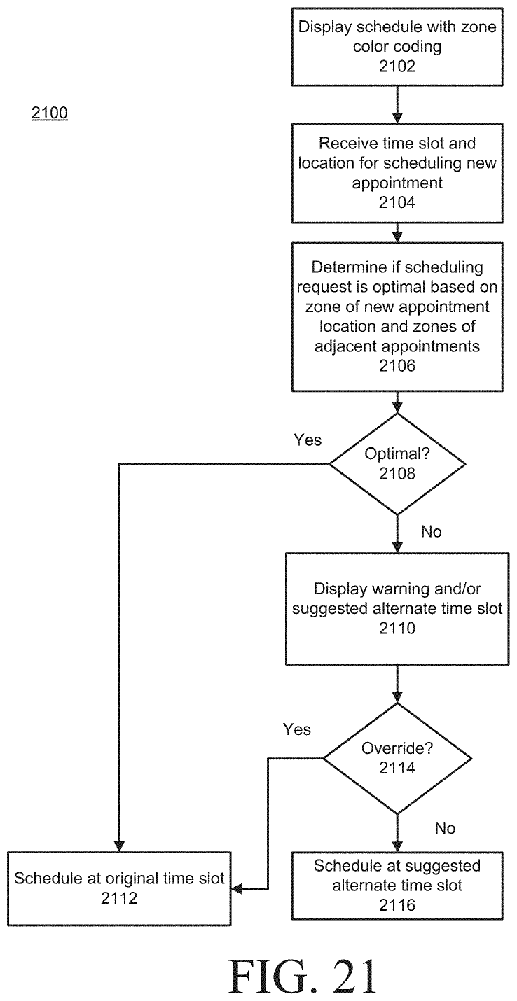

FIG. 21 is a flow diagram illustrating an example scheduling process 2100 utilizing zones (e.g., as shown in FIG. 20), according to some implementations.

In some implementations, method 2100 can be implemented, for example, on a server system 102 as shown in FIG. 1A. In other implementations, some or all of the method 2100 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 2100.

Some implementations can initiate method 2100 based on user input. A user may, for example, have selected the initiation of the method 2100 from a displayed user interface. In some implementations, method 2100 or portions thereof can be performed with guidance by the user via user input.

In some implementations, the method 2100, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 2100, and/or one or more other events or conditions occurring which can be specified in settings of a device implementing method 2100. In some implementations, such conditions can be previously specified by a user in stored custom preferences of the user (accessible by a device or method with user consent).

The method begins at block 2102, where a schedule (e.g., of appointments, projects, tasks, etc.) is displayed with zone color coding (e.g., as shown in FIG. 20). Processing continues to 2104.

At 2104, an electronic indication of time slot and location for a new appointment is received at the project management platform. The indication of the new appointment can include a time (e.g., date and time of day) and a location (e.g., an address or other location information). Processing continues to 2106.

At 2106, the project management platform determines if the scheduling request is optimal based on an area (or zone) of the appointment and locations of adjacent appointments. For example, the project management platform may determine that the scheduling request is not optimal if it is for a given zone and is requested to be adjacent to an appointment in a different zone and possibly with insufficient time to go from one appointment to another. In another example, the project management platform may determine that the scheduling request is optimal (or at least acceptable) when the location for the scheduling request is in a same zone as adjacent appointments or is in a different zone but provides sufficient time to go from appointment to appointment. Processing continues to 2108.

At 2108, if the scheduling request is optimal (or acceptable), processing continues to 2112, otherwise processing continues to 2110.

At 2110, a warning indicating that the scheduling request is not optimal and/or suggested alternate time slot are displayed by the project management platform. Processing continues to 2114.

At 2114, the project management platform determines if an indication to override the warning/suggested alternate time slot is received. If the indication to override is received, processing continues to 2112. Otherwise, processing continues to 2116.

At 2112, the appointment is scheduled at the originally requested time slot.

At 2116, the appointment is scheduled at the suggested new time slot.

In FIG. 21, various blocks (e.g., blocks 2102-2116) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

Block 2106 of FIG. 21 describes optionally utilizing a probabilistic model (or other type of model as described below in conjunction with FIG. 23) to determine or predict optimality of a scheduling request and/or to suggest an alternate time slot for a scheduling request.

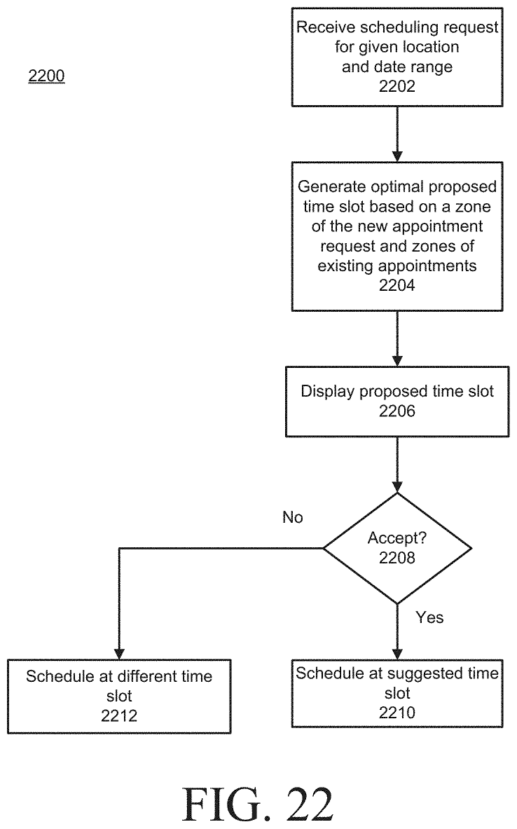

FIG. 22 is a flow diagram illustrating an example scheduling process utilizing the zones of FIG. 20, according to some implementations; FIG. 21 is a flow diagram illustrating an example scheduling process 2200 utilizing zones (e.g., as shown in FIG. 20), according to some implementations.

In some implementations, method 2200 can be implemented, for example, on a server system 102 as shown in FIG. 1A. In other implementations, some or all of the method 2200 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 2200.

Some implementations can initiate method 2200 based on user input. A user may, for example, have selected the initiation of the method 2200 from a displayed user interface. In some implementations, method 2200 or portions thereof can be performed with guidance by the user via user input.

In some implementations, the method 2200, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 2200, and/or one or more other events or conditions occurring which can be specified in settings of a device implementing method 2200. In some implementations, such conditions can be previously specified by a user in stored custom preferences of the user (accessible by a device or method with user consent).

The method begins at block 2202, where a scheduling request for a new appointment or changed appointment is received at the project management platform. In some implementations, the scheduling request can include a location and a date range. The scheduling request can be received from a mobile application or web page connected to the project management platform. Processing continues to 2204.

At 2204, an optimal proposed time slot is automatically generated by the project management platform based on a zone of the new appointment request and zones of existing appointments that have already been scheduled. In some implementations, the proposed time slot can be generated automatically by a probabilistic model or other machine learning model as described below in connection with FIG. 23. Inputs to the machine learning model can include currently scheduled appointments, customer availability for the new appointment, and/or a location (or zone) of the new appointment. Processing continues to 2206.

At 2206, the proposed time slot generated in 2204 is displayed. Processing continues to 2208.

At 2208, the system receives an indication of whether the proposed time slot is accepted. If so, processing continues to 2210. Otherwise, processing continues to 2212.

At 2210, the new appointment is scheduled at the proposed time slot and added to an electronic calendar of the project management platform and/or to an external appointment management system.

At 2212, the appointment is scheduled at a different time slot. For example, a user could manually enter a time slot to use for the appointment. In some implementations, the project management platform could propose another time different than the first proposed time slot.

In FIG. 22, various blocks (e.g., blocks 2202-2212) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

Block 2204 of FIG. 22 describes optionally utilizing a probabilistic model (or other type of model as described below in conjunction with FIG. 23) to determine or predict optimality of a scheduling request and/or to suggest an alternate time slot for a scheduling request.

FIG. 23 is a block diagram of an example device 2300 which may be used to implement one or more features described herein. In one example, device 2300 may be used to implement a client device, e.g., any of client devices 120-126 shown in FIG. 1A. Alternatively, device 2300 can implement a server device, e.g., server device 104, etc. In some implementations, device 2300 may be used to implement a client device, a server device, or a combination of the above. Device 2300 can be any suitable computer system, server, or other electronic or hardware device as described above.

One or more methods described herein (e.g., 134, 136, 138, 412, 140, 142, 2100, and/or 2200) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 2300 includes a processor 2302, a memory 2304, and I/O interface 2306. Processor 2302 can be one or more processors and/or processing circuits to execute program code and control basic operations of the device 2300. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 2302 may include one or more co-processors that implement neural-network processing. In some implementations, processor 2302 may be a processor that processes data to produce probabilistic output, e.g., the output produced by processor 2302 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 2304 is typically provided in device 2300 for access by the processor 2302, and may be any suitable processor-readable storage medium, such as random access memory (RAM), read-only memory (ROM), Electrically Erasable Programmable Read-only Memory (EEPROM), Flash memory, etc., suitable for storing instructions for execution by the processor, and located separate from processor 2302 and/or integrated therewith. Memory 2304 can store software operating on the server device 2300 by the processor 2302, including an operating system 408, machine-learning application 2330, project management platform application project management application 2312 project management application 2312, and application data 2314. Other applications may include applications such as a data display engine, web hosting engine, image display engine, notification engine, social networking engine, etc. In some implementations, the machine-learning application 2330 and project management platform application 2312 can each include instructions that enable processor 2302 to perform functions described herein, e.g., some or all of the methods of FIGS. 2-6, 21-22, and/or 25.

The machine-learning application 2330 can include one or more named entity recognition (NER) implementations for which supervised and/or unsupervised learning can be used. The machine learning models can include multi-task learning based models, residual task bidirectional LSTM (long short-term memory) with conditional random fields, statistical NER, etc. The Device can also include a project management platform application 2312 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 2330 may utilize Bayesian classifiers, support vector machines, neural networks, or other learning techniques. In some implementations, machine-learning application 2330 may include a trained model 2334, an inference engine 2336, and data 2332. In some implementations, data 432 may include training data, e.g., data used to generate trained model 2334. For example, training data may include any type of data suitable for training a model for project management platform tasks, such as images, labels, thresholds, etc. associated with the various project management phases and tasks described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 2334, training data may include such user data. In implementations where users permit use of their respective user data, data 2332 may include permitted data.

In some implementations, data 2332 may include collected data such as map data, image data (e.g., satellite imagery, overhead imagery, etc.), product or service selection data, supplier performance data, etc. In some implementations, training data may include synthetic data generated for the purpose of training, such as data that is not based on user input or activity in the context that is being trained, e.g., data generated from simulated conversations, computer-generated images, etc. In some implementations, machine-learning application 2330 excludes data 2332. For example, in these implementations, the trained model 2334 may be generated, e.g., on a different device, and be provided as part of machine-learning application 2330. In various implementations, the trained model 2334 may be provided as a data file that includes a model structure or form, and associated weights. Inference engine 2336 may read the data file for trained model 2334 and implement a neural network with node connectivity, layers, and weights based on the model structure or form specified in trained model 2334.

Machine-learning application 2330 also includes a trained model 2334. In some implementations, the trained model 2334 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 2332 or application data 2314. Such data can include, for example, images, e.g., when the trained model is used for project management platform functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for an image, an indication that an image is functional, etc. depending on the specific trained model. In some implementations, model form or structure also specifies a number and/or type of nodes in each layer.

In different implementations, the trained model 2334 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 2334 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 2332, to produce a result.

For example, training may include applying supervised learning techniques. In supervised learning, the training data can include a plurality of inputs (e.g., a set of images) and a corresponding expected output for each input (e.g., one or more labels for each image representing aspects of a project corresponding to the images such as services or products needed or recommended). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided and the model may be trained to differentiate data, e.g., to cluster input data into a plurality of groups, where each group includes input data that are similar in some manner. For example, the model may be trained to identify project management task labels that are associated with images and/or select thresholds for project management task recommendation.

In another example, a model trained using unsupervised learning may cluster words based on the use of the words in data sources. In some implementations, unsupervised learning may be used to produce knowledge representations, e.g., that may be used by machine-learning application 2330. In various implementations, a trained model includes a set of weights, or embeddings, corresponding to the model structure. In implementations where data 2332 is omitted, machine-learning application 2330 may include trained model 2334 that is based on prior training, e.g., by a developer of the machine-learning application 2330, by a third-party, etc. In some implementations, trained model 2334 may include a set of weights that are fixed, e.g., downloaded from a server that provides the weights.

Machine-learning application 2330 also includes an inference engine 2336. Inference engine 2336 is configured to apply the trained model 2334 to data, such as application data 2314, to provide an inference. In some implementations, inference engine 2336 may include software code to be executed by processor 2302. In some implementations, inference engine 2336 may specify circuit configuration (e.g., for a programmable processor, for a field programmable gate array (FPGA), etc.) enabling processor 2302 to apply the trained model. In some implementations, inference engine 2336 may include software instructions, hardware instructions, or a combination. In some implementations, inference engine 2336 may offer an application programming interface (API) that can be used by operating system 2308 and/or project management platform application 2312 to invoke inference engine 2336, e.g., to apply trained model 2334 to application data 2314 to generate an inference.

Machine-learning application 2330 may provide several technical advantages. For example, when trained model 2334 is generated based on unsupervised learning, trained model 2334 can be applied by inference engine 2336 to produce knowledge representations (e.g., numeric representations) from input data, e.g., application data 2314. For example, a model trained for project management tasks may produce predictions and confidences for given input information about a project being proposed or planned. A model trained for suggesting project management tasks may produce a suggestion for one or more phases of a project, or a model trained for automatic estimating or evaluation of a project or project phase may automatically estimate a project and/or evaluate completion of one or more phases of a project based on input images or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 2336.

In some implementations, knowledge representations generated by machine-learning application 2330 may be provided to a different device that conducts further processing, e.g., over a network. In such implementations, providing the knowledge representations rather than the images may provide a technical benefit, e.g., enable faster data transmission with reduced cost. In another example, a model trained for functional image archiving may produce a functional image signal for one or more images being processed by the model.

In some implementations, machine-learning application 2330 may be implemented in an offline manner. In these implementations, trained model 2334 may be generated in a first stage and provided as part of machine-learning application 2330. In some implementations, machine-learning application 2330 may be implemented in an online manner. For example, in such implementations, an application that invokes machine-learning application 2330 (e.g., operating system 2308, one or more of project management platform application 2312 or other applications) may utilize an inference produced by machine-learning application 2330, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 2334, e.g., to update embeddings for trained model 2334.

In some implementations, machine-learning application 2330 may be implemented in a manner that can adapt to particular configuration of device 2300 on which the machine-learning application 2330 is executed. For example, machine-learning application 430 may determine a computational graph that utilizes available computational resources, e.g., processor 2302. For example, if machine-learning application 2330 is implemented as a distributed application on multiple devices, machine-learning application 2330 may determine computations to be carried out on individual devices in a manner that optimizes computation. In another example, machine-learning application 430 may determine that processor 2302 includes a GPU with a particular number of GPU cores (e.g., 1000) and implement the inference engine accordingly (e.g., as 1000 individual processes or threads).

In some implementations, machine-learning application 2330 may implement an ensemble of trained models. For example, trained model 2334 may include a plurality of trained models that are each applicable to the same input data. In these implementations, machine-learning application 2330 may choose a particular trained model, e.g., based on available computational resources, success rate with prior inferences, etc. In some implementations, machine-learning application 2330 may execute inference engine 2336 such that a plurality of trained models is applied. In these implementations, machine-learning application 2330 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 408 or one or more other applications, e.g., project management platform application 2312.

In different implementations, machine-learning application 2330 can produce different types of outputs. For example, machine-learning application 2330 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 2330 may produce an output video with a particular effect applied, e.g., rendered in a comic-book or particular artist's style, when trained model 2334 is trained using training data from the comic book or particular artist, etc. In some implementations, machine-learning application 2330 may produce an output based on a format specified by an invoking application, e.g. operating system 2308 or one or more applications, e.g., project management platform application 2312. In some implementations, an invoking application may be another machine-learning application. For example, such configurations may be used in generative adversarial networks, where an invoking machine-learning application is trained using output from machine-learning application 2330 and vice-versa.

Any of software in memory 2304 can alternatively be stored on any other suitable storage location or computer-readable medium. In addition, memory 2304 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 2304 and any other type of storage (magnetic disk, optical disk, magnetic tape, or other tangible media) can be considered “storage” or “storage devices.”

I/O interface 2306 can provide functions to enable interfacing the server device 2300 with other systems and devices. Interfaced devices can be included as part of the device 400 or can be separate and communicate with the device 2300. For example, network communication devices, storage devices (e.g., memory and/or database 106), and input/output devices can communicate via I/O interface 2306. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 2306 can include one or more display devices 2320 and one or more data stores 2338 (as discussed above). The display devices 2320 that can be used to display content, e.g., a user interface of an output application as described herein. Display device 2320 can be connected to device 400 via local connections (e.g., display bus) and/or via networked connections and can be any suitable display device. Display device 2320 can include any suitable display device such as an LCD, LED, or plasma display screen, CRT, television, monitor, touchscreen, 3-D display screen, or other visual display device. For example, display device 2320 can be a flat display screen provided on a mobile device, multiple display screens provided in a goggles or headset device, or a monitor screen for a computer device.

The I/O interface 2306 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 23 shows one block for each of processor 2302, memory 2304, I/O interface 2306, and software blocks 2308, 2312, and 2330. These blocks may represent one or more processors or processing circuitries, operating systems, memories, I/O interfaces, applications, and/or software modules. In other implementations, device 2300 may not have all of the components shown and/or may have other elements including other types of elements instead of, or in addition to, those shown herein. While some components are described as performing blocks and operations as described in some implementations herein, any suitable component or combination of components of environment 100, device 2300, similar systems, or any suitable processor or processors associated with such a system, may perform the blocks and operations described.

In some implementations, logistic regression can be used for personalization (e.g., personalizing functional image archiving suggestions based on a user's pattern of archiving activity). In some implementations, the prediction model can be handcrafted including hand selected functional labels and thresholds. The mapping (or calibration) from ICA space to a predicted precision within the functional image archiving space can be performed using a piecewise linear model.

In some implementations, the functional image archiving system could include a machine-learning model (as described herein) for tuning the system (e.g., selecting functional image labels and corresponding thresholds) to potentially provide improved accuracy. Inputs to the machine learning model can include ICA labels, an image descriptor vector that describes appearance and includes semantic information about an image, where two images with similar feature vectors tend to look the same. Example machine-learning model input can include labels for a simple implementation and can be augmented with image descriptor vector features for a more advanced implementation. Output of the machine-learning module can include a prediction of how likely a user is to want to archive an image should a suggestion to archive the image be surfaced.

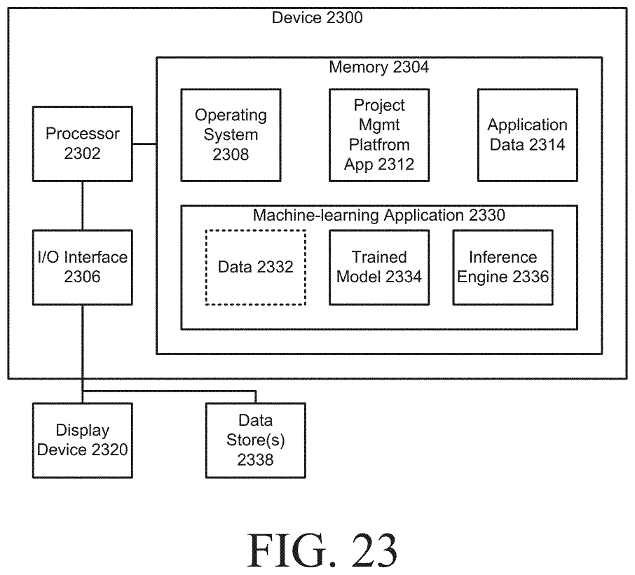

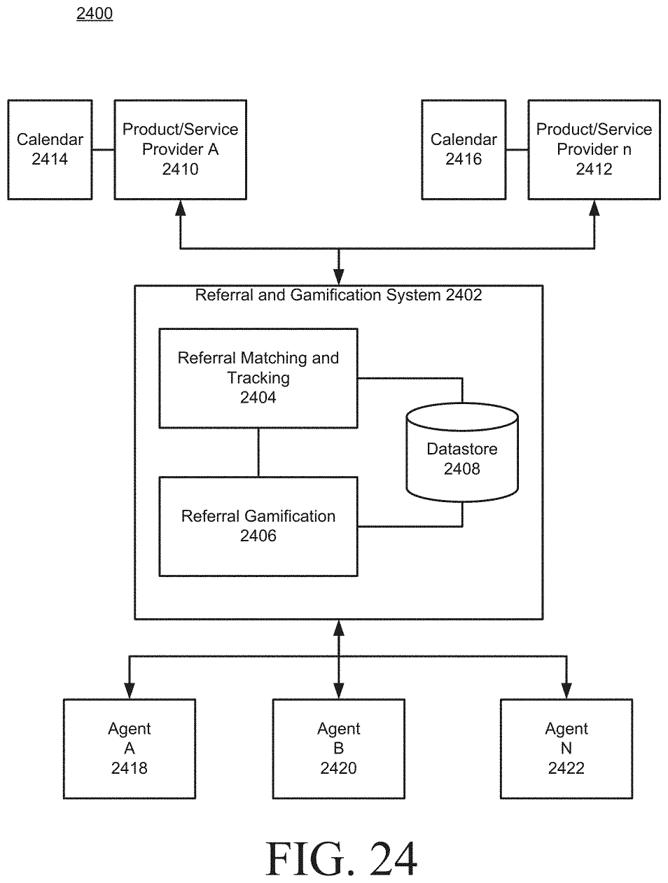

FIG. 24 is a block diagram of an example referral and referral gamification system environment 2400 in accordance with some implementations. The referral and referral gamification system environment 2400 includes a referral gamification system 2402 having a referral matching and tracking module 2404, a referral gamification module 2406, and a referral datastore 2408, which can all be separate systems or integrated with a project management platform as described herein.

The referral and gamification system 2402 is connected to one or more product and/or service provider systems (e.g., 2410, 2412) that each have a corresponding calendar (e.g., 2414 and 2416). Also, connected to the referral and gamification system 2402 are one or more referral agent systems (e.g., 2418, 2420, and 2422).

In operation, a client or customer of a referral agent may need a particular product or service. For example, the referral agent may be a real estate agent and the client is a person selling a home. The client may need services for the home in order to better present it on the market for sale, such as painting, roofing, sod, etc. The agent via a system of the agent (e.g., 2418) such as a mobile device or a computer, accesses the referral and gamification platform 2402 (e.g., via a mobile application or a web portal). The agent 2418 selects a service that is needed by the client and for which the referral and gamification system 2402 has a provider. The referral and gamification system 2402 selects a service provider that is already registered with the referral and gamification system 2402 and connects the agent (2418) with a product/service provider (e.g., 2410) and allows the agent 2418 to add an appointment to the calendar 2414 of the product/service provider 2410.

Because the referral and gamification system 2402 present just one product/service provider to the agent, product and service providers registered with the referral and gamification system are not competing with each other for the same lead. The referral and gamification app serves up one company for that referral. The referral system can rotate referrals to product/service providers registered in the system for given geographical service areas. Also, product/service providers can pause (and unpause) participation in the referral system (e.g., for vacation, etc.) and not be in list of providers in rotation for referrals when paused.

In some implementations, service providers are not competing for the same lead, as each provider is the only one that receives a particular lead, however, service providers are in fact competing for leads in that the platform will use an algorithm, or multiple algorithms to make determinations about which provider a particular lead goes to. This can be based upon one or more of lead response time (e.g., time it takes to call the customer and make contact once a lead has been given), time to set and attend appointment with the lead, closed sales, customer rating, etc., all of which can be tracked through the platform. This service provider performance and responsiveness data can be analyzed to create weighted averages for each service provider or supplier to determine how many times each service provider or supplier gets recommend when an agent is seeking a service provider or supplier. For example, there may be three roofing companies in the platform, and initially they will each get one of three leads, however, as the platform begins collecting the performance and responsiveness data noted above, the platform will start favoring certain suppliers over others because their overall rating is better than another supplier. This can also be used to maintain a minimum standard of service that must be maintained to even stay in the platform and receive referrals.

In some implementations, the referral and gamification system tracks appointments and gives credit to agent for scheduled appointments. In some implementations, providers do not pay for leads, but rather only pay when the lead gets added to calendar. In some implementations, a provider may not pay anything for the lead, but rather pay a commission for completed work that was paid for by the client (e.g., a percentage on backside of job, where the referral agent gets a portion, the referral and gamification system operator gets a portion, and optionally a broker the agent works for can receive a portion. Under the commission system there is no lead gen cost and no competition between providers for the same lead.

Product/service providers can be verified by the referral and gamification system operator (e.g., through background checks, license verification, insurance verification, etc.) and the referral and gamification system can include a ratings system for product/service providers where the providers are rated by the client and/or agents. The referral system may have a threshold rating value that a product or service provider must maintain in order to be in rotation for receiving a lead (e.g., 4.0 out of 5 stars, etc.).

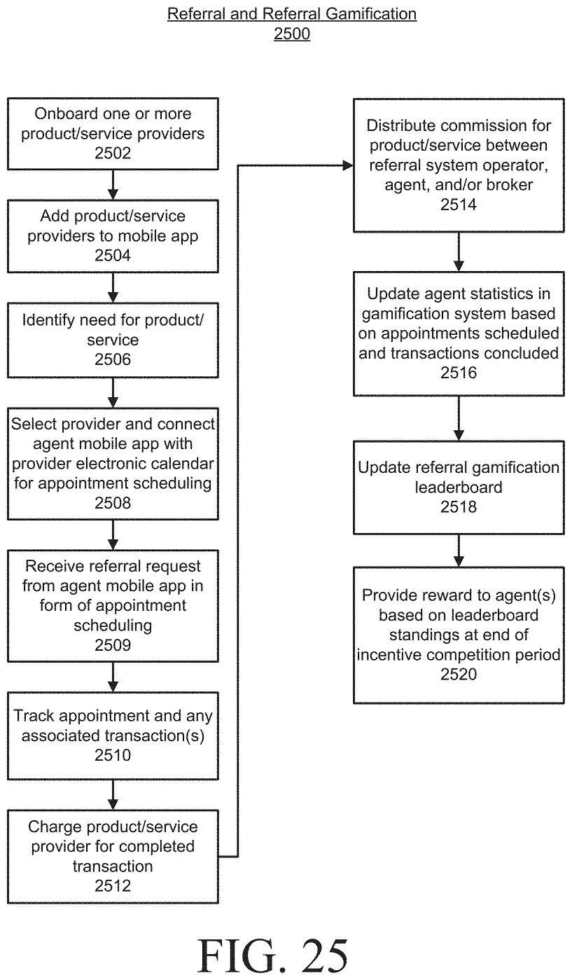

FIG. 25 is a flowchart of an example method 2500 for referral and referral gamification in accordance with some implementations.

In some implementations, method 2500 can be implemented, for example, on a server system 102 as shown in FIG. 1A. In other implementations, some or all of the method 2500 can be implemented on one or more client devices 120, 122, 124, or 126 as shown in FIG. 1A, one or more server devices, and/or on both server device(s) and client device(s). In described examples, the implementing system includes one or more digital hardware processors or processing circuitry (“processors”), and one or more storage devices (e.g., a database 106 or other storage). In some implementations, different components of one or more servers and/or clients can perform different blocks or other parts of the method 2500.

Some implementations can initiate method 2500 based on user input. A user may, for example, have selected the initiation of the method 2100 from a displayed user interface. In some implementations, method 2500 or portions thereof can be performed with guidance by the user via user input.

In some implementations, the method 2500, or portions of the method, can be initiated automatically by a device. For example, the method (or portions thereof) can be periodically performed or performed based on the occurrence of one or more particular events or conditions. For example, such events or conditions can include a particular application being opened by a user, an elapsed time since obtaining one or more images that have been captured by, uploaded to, or otherwise accessible by a device (e.g. a user device), a predetermined time period having expired since the last performance of method 2500, and/or one or more other events or conditions occurring which can be specified in settings of a device implementing method 2500. In some implementations, such conditions can be previously specified by a user in stored custom preferences of the user (accessible by a device or method with user consent).

The method begins at block 2502, where one or more product/service providers are onboarded to the referral system (e.g., via the onboarding process described shown in FIG. 6 and described above as part of the project management platform). In addition to the onboarding process described above regarding FIG. 6, onboarding for the referral system can also include manual or automatic vetting of product/service provider credentials such as licenses, insurance, online customer reviews, etc. Processing continues to 2504.

At 2504, onboarded product/service providers are added to the product/service providers for selection display in the referral mobile application and/or via a web portal. In some implementations, there may be a single product/service provider in the referral system for a category (e.g., painting, roofing, etc.). In some implementations, there may be more than one product/service provider in a category and the referral systems selects a service provider to display to an agent based on rotation or other selection process. Processing continues 2506.

At 2506, an indication of a need for one or more products or services are identified. For example, a referral agent, such as a real estate agent, may identify that a property listed for sale needs one or more services to be in a better marketing position. Processing continues 2508.

At 2508, a provider is selected for a corresponding product or service need and the referral agent mobile application (or portal) is connected to the selected provider (e.g., a connection is established between the agent mobile app or portal and an electronic calendar of the provider). Selection of the provider can be based on the service need and a location the service is to be performed. The selection can be done through various techniques such as a rotation. Another selection technique can include selecting a best rated product/service provider. In some implementations, the selection technique can include a rotation where the providers in rotation are weighted by their respective ratings or other performance criteria. Processing continues to 2509.

At 2509, a referral request from an agent mobile application (or portal) in the form of a scheduled appointment is received. The scheduled appointment could be added to an electronic calendar of the service provider selected for the referral. Processing continues to 2510. In some implementations, the project management platform will notify the product/service provider that a client is being referred to them by providing them with a telephone number that was auto-generated by the platform. The number, when dialed, is routed through the platform directly to the client's mobile or land-based telephone, where the call can be recorded and stored in a data storage device coupled to the platform.

At 2510, scheduled appointments and any associated transactions are tracked. For example, in some implementations, the project management platform and the product/service provider platform may exchange information about appointments and transactions from clients referred to the product/service provider by the referral and gamification system. In another implementation, the referral and gamification system can handle the appointment scheduling and payment processing for referred clients and can distribute proceeds from the payments according to commission percentages for the referrals. In another implementation, the referral and gamification system can receive a payment from the product/service provider for a scheduled appointment and no further payment for products or services purchased by the client referred to the product/service provider. Processing continues to 2512.

At 2512, the product/service provider is optionally charged for completed transactions (e.g., transactions in which payment from the client was received by the product/service provider). For example, based on the appointment scheduling and transaction tracking information received at the referral and gamification system, the system can determine that a transaction was completed for a client that the referral system had sent to the provider. Based on the indication of a completed transaction for a referred client, the referral system can charge the product/service provider for the referral fee (or commission). Processing continues to 2514.

At 2514, the commission received from charging the client at block 2512 can be distributed to the referral system operator, referral agent, and/or broker. Processing continues to 2516.

In some implementations, the platform provides a professional follow up tool for the referring agent, including sending the client e-mails and/or text messages professionally written and auto-generated by the platform upon completion of certain events. For example, if an agent refers a client to a provider by either setting the appointment for the client within the platform, or generating a telephone number and having the platform send the number and client information to the provider, then an e-mail is generated to the client from the referral agent as if they'd written it themselves. Additional professionally written follow up e-mails can be sent throughout the entire project until it is complete. This professional engagement and follow up service is automatically performed by the platform and solves technical problems associated with conventional referrals systems that do not provide automatic follow up to clients from a referring agent to track progress of a referred project.

At 2516, statistics (or scores) for the referral agent are updated in the gamification system based on measured activities such as appointments scheduled, transactions completed, total dollar value of transactions completed, average dollar value of transactions, etc. over a given time period (e.g., a month, a quarter, etc.). Processing continues to 2518.

At 2518, a referral gamification leaderboard is optionally updated. The leaderboard can reflect the ranking of referral agents according to one or more of the measured activities mentioned above at block 2516. Processing continues to 2520.

At 2520, a prize or incentive award is provided to one or more referral agents based on leaderboard standings at the end of an incentive competition period.

In FIG. 25, various blocks (e.g., blocks 2502-2520) are illustrated as being performed sequentially. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

Block 2510 of FIG. 25 describes optionally utilizing a probabilistic model (or other type of model as described in conjunction with FIG. 23) to determine or predict optimality of a scheduling request and/or to suggest an alternate time slot for a scheduling request.

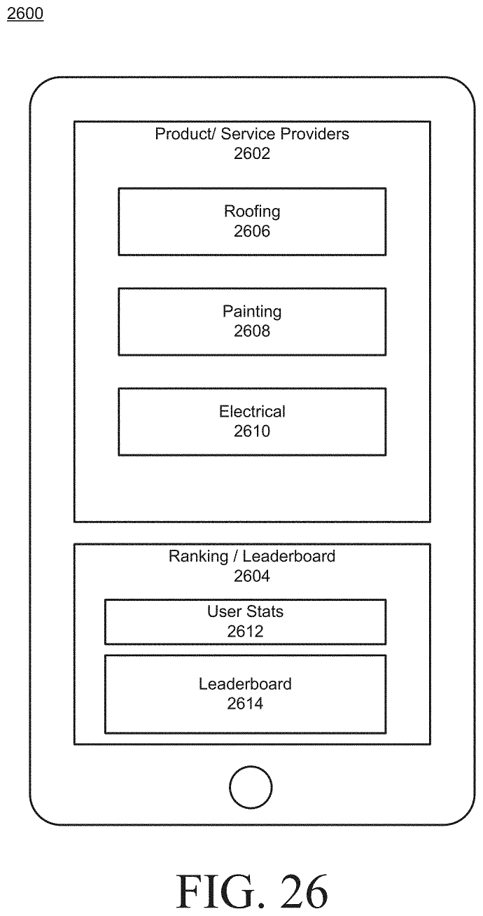

FIG. 26 is a diagram of an example referral and referral gamification mobile application graphical user interface 2600 in accordance with some implementations. The referral and referral gamification mobile application graphical user interface 2600 includes a product/service provider section 2602 and a ranking leaderboard section 2604.

The product/service provider section 2602

One or more methods described herein (e.g., method 134, 136, 138, 412, 140, 142, 2100, 2200, and/or 2500) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

1. A computer-implemented method to operate a project management platform, the method comprising:
automatically generating, at one or more processors, an inbound marketing telephone number associated with a first entity;
associating, at the one or more processors, the inbound marketing telephone number with a second entity different from the first entity in a database of the project management platform, wherein the second entity is a referral source, wherein the automatically generating and the associating are performed in response to a request to generate and associate an inbound marketing telephone number with the second entity;
receiving, at the one or more processors, an inbound telephone call from a third entity and dialed number identification information that identifies a dialed number of the inbound telephone call as the inbound marketing telephone number;
routing, using the one or more processors, the inbound telephone call to a telephone functionality associated with the first entity within the project management platform;
receiving, at the one or more processors, electronic scheduling information for a new appointment for the third entity associated with the inbound telephone call;
adding, using the one or more processors, pending electronic referral payout information to the database, where the pending electronic referral payout information is directed to the referral source associated with the dialed telephone number corresponding to the automatically generated inbound marketing telephone number; and
when an electronic payment from the third entity is received by the first entity, completing a pending electronic referral payout corresponding to the pending electronic referral payout information and making the pending electronic referral payout to the second entity.

2. The computer-implemented method of claim 1, wherein the electronic scheduling information for the new appointment includes a new appointment location, and wherein the method further includes displaying a color-coded calendar showing existing appointments color coded by a geographic location zone.

3. The computer-implemented method of claim 2, wherein the method further includes generating and displaying a warning if an attempt is made to schedule the new appointment at a time slot adjacent to an existing appointment having a location in a zone different from a zone associated with the new appointment location.

4. The computer-implemented method of claim 3, wherein the method further includes automatically suggesting a proposed time slot for the new appointment, wherein the proposed time slot is adjacent to an existing appointment in a same zone as the new appointment location.

5. The computer-implemented method of claim 4, wherein automatically suggesting the proposed time slot includes determining the proposed time slot based on a location of one or more adjacent existing appointments to the proposed time slot and providing sufficient time between the proposed time slot and the one or more adjacent existing appointments for travel between appointment locations.

6. The computer-implemented method of claim 1, wherein the inbound marketing telephone number is automatically generated as part of a referral source onboarding process.

7. The computer-implemented method of claim 1, further comprising associating the referral source with a referral payment card account.

8. The computer-implemented method of claim 7, wherein the referral payment card account is a tenant account of a master account associated with an operator of the project management platform.

9. The computer-implemented method of claim 8, wherein the referral payment card account is associated with a branded payment card having a brand of the operator of the project management platform applied to the branded payment card.

10. A project management platform system comprising:
one or more processors coupled to a computer-readable medium having stored thereon software instructions that, when executed by the one or more processors, cause the one or more processors to perform operations including:
automatically generating, at the one or more processors, an inbound marketing telephone number associated with a first entity;
associating, at the one or more processors, the inbound marketing telephone number with a second entity different from the first entity in a database of the project management platform, wherein the second entity is a referral source, wherein the automatically generating and the associating are performed in response to a request to generate and associate an inbound marketing telephone number with the second entity;
receiving, at the one or more processors, an inbound telephone call from a third entity and dialed number identification information that identifies a dialed number of the inbound telephone call as the inbound marketing telephone number;
routing, using the one or more processors, the inbound telephone call to a telephone functionality associated with the first entity within the project management platform;
receiving, at the one or more processors, electronic scheduling information for a new appointment for the third entity associated with the inbound telephone call;
adding, using the one or more processors, pending electronic referral payout information to the database, where the pending electronic referral payout information is directed to the referral source associated with the dialed telephone number corresponding to the automatically generated inbound marketing telephone number; and
when an electronic payment from the third entity is received by the first entity, completing a pending electronic referral payout corresponding to the pending electronic referral payout information and making the pending electronic referral payout to the second entity.

11. The project management platform system of claim 10, wherein the electronic scheduling information for the new appointment includes a new appointment location, and wherein the operations further include displaying a color-coded calendar showing existing appointments color coded by a geographic location zone.

12. The project management platform system of claim 11, wherein the operations further include generating and displaying a warning if an attempt is made to schedule the new appointment at a time slot adjacent to an existing appointment having a location in a zone different from a zone associated with the new appointment location.

13. The project management platform system of claim 12, wherein the operations further include automatically suggesting a proposed time slot for the new appointment, wherein the proposed time slot is adjacent to an existing appoint in a same zone as the new appointment location.

14. The project management platform system of claim 13, wherein automatically suggesting the proposed time slot includes determining the proposed time slot based on a location of one or more adjacent existing appointments to the proposed time slot and providing sufficient time between the proposed time slot and the one or more adjacent existing appointments for travel between appointment locations.

15. The project management platform system of claim 10, wherein the inbound marketing telephone number is automatically generated as part of a referral source onboarding process.

16. The project management platform system of claim 10, further comprising associating the marketing campaign with a referral payment card account.

17. The project management platform system of claim 16, wherein the referral payment card account is a tenant account of a master account associated with an operator of the project management platform.

18. The project management platform system of claim 17, wherein the referral payment card account is associated with a branded payment card having a brand of the operator of the project management platform applied to the branded payment card.

19. A non-transitory computer-readable medium having stored thereon software instructions that, when executed by one or more processors, cause the one or more processors to perform operations including:
automatically generating, at the one or more processors, a unique referral link and an inbound marketing telephone number associated with a first entity;
associating, at the one or more processors, the unique referral link and the inbound marketing telephone number with a second entity different from the first entity in a database of a project management platform, wherein the second entity is a referral source, wherein the unique referral link is operable to schedule an appointment with the first entity and is associated with the second entity for referral payments to the second entity;
receiving, at the one or more processors, an inbound telephone call from a third entity and dialed number identification information that identifies a dialed number of the inbound telephone call as the inbound marketing telephone number associated with the referral source;
routing, using the one or more processors, the inbound telephone call to a telephone functionality associated with the first entity within the project management platform;
receiving, at the one or more processors, electronic scheduling information for a new appointment for the third entity associated with the inbound telephone call;
adding, using the one or more processors, pending electronic referral payout information to the database, where the pending electronic referral payout information is directed to the referral source associated with the unique referral link; and
when an electronic payment from the third entity is received by the first entity, completing a pending electronic referral payout corresponding to the pending electronic referral payout information and making the pending electronic referral payout to the second entity.

20. The non-transitory computer-readable medium of claim 19, wherein the electronic scheduling information for the new appointment includes a new appointment location, and wherein the operations further include displaying a color-coded calendar showing existing appointments color coded by a geographic location zone.
